(19) United States
(12) Patent Application Publication
(10) Pub. No.: US 2026/0307822 A1
(43) Pub. Date: Oct. 8, 2026

(54) SPACECRAFT LIQUID TRANSPORT SYSTEM

(71) Applicant: Space Ocean Corp., Brownsville, TX (US)

(72) Inventors: Alden Fuchs, Leesburg, VA (US); Sean David Keppler, Linthicum Heights, MD (US); Charles McGinn, Clinton, MA (US); Aidan Foy, Tampa, FL (US); Madhusudhan N. Kundrapu, Thornton, CO (US); Diego Vasquez, Chino Hills, CA (US); Christopher Williams, Mount Angel, OR (US); Brendan Uribe, San Diego, CA (US)

(21) Appl. No.: 19/170,972

(22) Filed: Apr. 4, 2025

(51) Int. Cl. B64G 1/22

(52) U.S. Cl. CPC B64G 1/223; B64G 1/46

(57) ABSTRACT

In one embodiment, a system for transporting a liquid in space comprises one or more expandable containers configured to store a liquid, wherein each container comprises a flexible, collapsible material. The system further comprises a pressure control system in mechanical communication with the container. The pressure control system is configured to apply an external force to maintain an internal pressure sufficient to keep the liquid in a liquid state in a vacuum environment. The system further comprises a fluid transport assembly coupled to the container, wherein the fluid transport assembly comprises at least one nozzle or valve configured for controlled intake and dispensing of the liquid. A control system is further configured to regulate the operation of the pressure control system and the fluid transport assembly to enable controlled intake and dispensing of the liquid.

### FIELD

The present disclosure relates to fluid storage and transport in spacecraft operations, specifically, systems and methods for receiving, maintaining, and/or dispensing a liquid in a controlled manner in the vacuum of space.

### BACKGROUND

As space operations expand beyond traditional satellite communications and research missions, the need for in-space resource logistics has grown increasingly urgent. Water, in particular, is an essential multipurpose resource with broad utility across human spaceflight, scientific research, and industrial applications. It is used not only for life support—drinking, hygiene, oxygen generation—but also in agriculture, radiation shielding, energy storage, fuel production, thermal regulation, and propulsion. Moreover, water's chemical composition makes it an ideal candidate for electrolysis to generate hydrogen and oxygen for use as rocket fuel or breathable air.

Despite its value, transporting and storing water in space presents significant technical challenges. In microgravity and vacuum environments, water will vaporize unless maintained under pressure and can freeze or overheat without careful thermal regulation. Conventional rigid tanks are bulky, mass-intensive, and not easily scalable or adaptable for emerging space operations like space tourism, in-orbit servicing, or lunar and planetary missions. Accordingly, there is a need for scalable, adaptable systems for transporting and storing water and other fluids in space.

### BRIEF SUMMARY

The present disclosure provides systems and methods that can maintain fluids in their liquid state across a range of environmental conditions, support modular interconnection for flexible logistics planning, and offer compatibility with autonomous transport vehicles and various use-case payloads. The present disclosure addresses these needs by providing expandable container systems with integrated pressure and temperature control mechanisms for the safe and efficient transport of liquids in outer space.

In one embodiment, a system for transporting a liquid in space comprises one or more expandable containers configured to store a liquid, wherein each container comprises a flexible, collapsible material. The system further comprises a pressure control system in mechanical communication with the container. The pressure control system is configured to apply an external force to maintain an internal pressure sufficient to keep the liquid in a liquid state in a vacuum environment. The system further comprises a fluid transport assembly coupled to the container, wherein the fluid transport assembly comprises at least one nozzle or valve configured for controlled intake and dispensing of the liquid. A control system is further configured to regulate the operation of the pressure control system and the fluid transport assembly to enable controlled intake and dispensing of the liquid.

In some embodiments, the liquid stored and transported is a non-volatile fluid, such as water or oil. In other embodiments, the liquid is a volatile fluid, such as a hydrocarbon-based fluid comprising methane, butane, or natural gas. The system may be compatible with a wide range of fluids, including those used for life support, propulsion, energy production, or scientific applications. In some embodiments, the container has a capacity of at least 500 liters, and in further embodiments, the container is scalable to hold 1500, 3000, 5000, or more liters of liquid. The container may include one or more ports to support modular or inter-module connectivity.

In some embodiments, the system further comprises a temperature control system in thermal communication with the container, the temperature control system being configured to regulate the temperature of the liquid to prevent freezing or boiling. For example, in embodiments where the fluid is water, the temperature control system may maintain the water at a temperature between 10° C. and 95° C.

In some embodiments, the pressure control system is further configured to regulate both intake and release of the liquid through the fluid transport assembly. The pressure control system may be configured to maintain an internal pressure of at least 0.0425 bar. In some embodiments, the pressure control system can support internal pressures from near vacuum up to several bars.

In some embodiments, the pressure control system comprises one or more inflatable bladders or donuts surrounding the container, each of which can apply external pressure when inflated. In some embodiments, the pressure control system comprises a liquid crystal polymer (LCP) layer that applies tension to the container to maintain internal pressure. In some embodiments, the pressure control system comprises one or more belts or straps surrounding the container, wherein constricting the belts (e.g., using strap motors) generates pressure. The belts may also be configured to anchor the system to a frame or other support structure. In some embodiments, the pressure control system comprises a lattice structure surrounding the container, wherein constriction of the lattice applies uniform external pressure. The lattice may be tensioned, for example, by stretching it laterally using one or more expandable arms or mechanical actuators.

In some embodiments, the system comprises two or more expandable containers, which may be stacked, co-mounted, or enclosed within a common frame to increase fluid storage capacity or enable modular fluid transport.

In some embodiments, the expandable container comprises at least three layers: (1) an outer protective layer providing shielding from radiation and micrometeoroids; (2) a structural layer providing tensile strength and pressure resistance; and (3) a primary bladder layer providing flexibility, impermeability, and thermal protection. The container may also incorporate heating elements, filtering systems, or multi-port configurations to facilitate intake, dispensing, and purification of stored fluids.

In some embodiments, the fluid transport assembly comprises one or more electric pumps to supplement pressure-driven transport, and may include two or more nozzles or valves, e.g., one positioned at a proximal end and one at a distal end, to support multidirectional flow or modular connectivity. In other embodiments, the fluid transport assembly is configured to provide thrust, such as by expelling the fluid (e.g., water or gas) through a nozzle, optionally using plasma or resistive heating to convert the fluid to a high-energy state for propulsion.

In some embodiments, the system is designed for modular deployment, including configurations where two or more liquid transport systems are stacked within a common frame or secured in series using both frame-based and fluid-assembly-based connections. In some embodiments, the system may be secured to a spacecraft, such as the International Space Station, a crewed vehicle, or an autonomous logistics vehicle (ALV), using mechanical attachments and fluid couplings to allow for refueling, water delivery, or other fluid transfer operations.

In another embodiment, the disclosure provides a method of transporting a fluid in outer space, the method comprising: storing the fluid in an expandable container; applying external pressure to the container using a pressure control system to maintain an internal pressure sufficient to keep the fluid in a liquid state in a vacuum environment; regulating the temperature of the fluid to prevent freezing; and controlling intake and dispensing of the fluid through a fluid transport assembly.

In some embodiments, applying external pressure to the container comprises inflating one or more bladders surrounding the container. In other embodiments, the step comprises constricting one or more belts surrounding the container. In some embodiments, the controlled dispensing of liquid through the fluid transport assembly generates thrust, enabling propulsion or repositioning of the system in space.

### BRIEF DESCRIPTION OF THE FIGURES

The novel features of the invention are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a diagram depicting an exemplary embodiment of a liquid transport system according to the disclosure;

FIGS. 2A-2B are cross-sectional views of a container according to one embodiment of the disclosure;

FIG. 3A is a cross-sectional view of a fluid transport network comprising two interconnected liquid transport systems, and FIG. 3B is a side view of the fluid transport network of FIG. 3A connected to a spacecraft, such as the International Space Station (ISS);

FIGS. 4A-4B are side views of fluid transport networks connected to autonomous logistical vehicles for repositioning or maneuvering in orbit;

FIG. 5A is a side view of an inflatable tube (donut-based) pressure control system according to one embodiment of the disclosure, and FIGS. 5B-5D include a side view, cross-sectional view, and isometric view, respectively, of an inflatable tube pressure control system according to another embodiment;

FIGS. 6A-6B are a side view and cross-sectional view, respectively, of a dual-bag pressure control system according to another embodiment of the disclosure, and FIGS. 6C-6D are cross-sectional views of a dual-bag pressure control system comprising a mechanically constrictive outer bag, according to another embodiment of the disclosure;

FIG. 7A is a side view of a strap-based pressure control system according to one embodiment, and FIGS. 7B-7C are side and isometric cross-sectional views, respectively, of the strap-based pressure control system of FIG. 7A;

FIGS. 8A-8C are side views of a lattice-based pressure control system according to various embodiments;

FIGS. 9A-9C are front views of multi-bag pressure control systems according to different embodiments, including donut- and strap-based configurations, and FIG. 9D is an isometric view of a multi-bag configuration using straps according to one embodiment; and

FIG. 10 is a flowchart depicting a method of transporting a fluid in outer space according to one embodiment of the disclosure.

### DETAILED DESCRIPTION

Water is likely to become one of the most valuable commodities in space. It can be harvested, stored, and transported between different locations, such as Earth orbit, lunar bases, Martian settlements, and asteroid mining stations, creating an interplanetary water economy. The ability to transport large quantities of water efficiently enables commercial trade, resource exchanges, and economic sustainability in future space-based industries. The ability to store and transport water efficiently in space has profound implications for human survival, scientific research, energy production, and interplanetary commerce. Liquid transport systems as described herein are designed to support a broad range of applications, making them an essential component of future space missions, orbital infrastructure, and deep-space exploration.

### A. System Overview

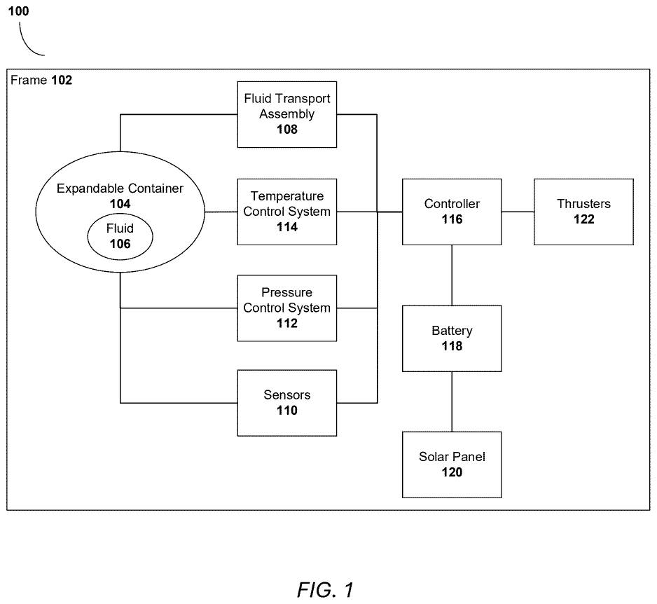

FIG. 1 depicts an exemplary liquid transport system 100 according to an embodiment of the disclosure. As shown in FIG. 1, the liquid transport system 100 can comprise a frame 102, which serves as a chassis to house and support the individual components of the system. The liquid transport system 100 can further comprise an expandable container 104, which can be made from a flexible, collapsible material that allows it to expand to store a fluid 106 and collapse as the fluid 106 is expelled. Materials used in the container 104 and frame 102 are preferably selected for long-term durability under launch stresses and storage conditions. In some embodiments, the system may be stowed for extended durations before deployment without degradation of function.

The system 100 can also comprise a fluid transport assembly 108, which is coupled to the container 104 and configured to intake and dispense the fluid 106. The fluid transport assembly 108 can be regulated by a controller 116, which may coordinate fluid movement, pressure regulation, and system functions. To ensure that the fluid 106 remains in a liquid state in a vacuum environment, the system 100 can comprise a pressure control system 112 in mechanical communication with the container 104. The pressure control system 112 can be configured to apply an external force to maintain an internal pressure sufficient to prevent vaporization of the fluid 106. Additionally, the system 100 can comprise a temperature control system 114 in thermal communication with the container 104 to regulate the temperature of the fluid 106 to prevent freezing or boiling. The pressure control system 112 and temperature control system 114 may operate in tandem, adjusting parameters in accordance with thermodynamic principles

$$( e . g . , Gas Laws , P = \frac{n R T}{V} )$$

to maintain the fluid 106 in its liquid state.

The controller 116 is configured to regulate the operation of the pressure control system 112, the temperature control system 114, and the fluid transport assembly 108, enabling precise control over fluid intake, storage, and dispensing. The system 100 can further include a sensor array 110, which may comprise pH sensors, temperature sensors, pressure sensors, radiation detectors, and conductivity sensors to monitor fluid conditions and environmental parameters. These sensors 110 can communicate with the controller 116, allowing for automated adjustments to pressure, temperature, and fluid transport in response to real-time conditions. In some embodiments, the system 100 may also comprise a water treatment and filtration system, which can include chemical treatments, biological filtration (e.g., zeolite), or mesh intake filters to ensure fluid purity.

To support sustained operations, the system 100 can comprise a battery 118 and a power source, such as a solar panel 120, providing energy for system functions and autonomous operation. Additionally, thrusters 122 may be included to enable controlled movement in a vacuum environment, allowing for fluid transport, station-keeping, or repositioning within an orbital or deep-space environment. In some embodiments, the system 100 is designed for extended autonomous operation without maintenance for durations exceeding one year, including through the use of radiation-tolerant electronics, sealed components, and passive pressure control mechanisms. In some embodiments, the system 100 is designed to operate within both pressurized and unpressurized compartments, making it suitable for internal station use as well as external payload bays or exposed truss-mounted deployment.

### B. System Components

Various embodiments of components and functions of liquid transport systems, such as the system 100, will now be described in further detail.

i. Frame

In some embodiments, the frame 102 may be designed to provide structural support, protection, and modular integration for all components. It may be constructed from lightweight, high-strength materials such as aluminum alloys, titanium, or composite materials to minimize mass while maintaining rigidity and durability in both launch and operational environments. The frame 102 can be configured to fit within payload delivery systems of orbital-class launch vehicles and stackable satellite architectures. For example, the frame 102 may be designed to conform to high-aspect ratio (HAR) satellite profiles, flat-disk form factors, or other high-density configurations used in modern deployment systems. These include but are not limited to SpaceX's Starlink platforms (e.g., v1 dimensions of 2.8 m×1.4 m×0.2 m and v2 Mini dimensions of 7.0 m×4.1 m×0.6 m), Rocket Lab's Flatellite platform, the Aerospace Corporation's flat-disk satellite design, and other stackable formats used in commercial, government, and defense-oriented small satellite constellations.

As will be described in further detail herein, the frame 102 can be modular, allowing multiple units to be stacked or interconnected to increase fluid storage capacity or enable fluid transfer between systems. In some embodiments, the frame 102 may be configured to connect with external spacecraft, such as the International Space Station (ISS), other liquid transport systems, or satellites requiring fluid resupply. Additionally, the frame may incorporate attachment points or standardized docking interfaces to facilitate secure integration with other spacecraft, refueling depots, or orbital infrastructure.

ii. Expandable Container

In some embodiments, the container 104 can be constructed from a variety of materials suited for both internal (e.g., not exposed to vacuum) and external (e.g., exposed to vacuum) environments. The choice of materials is based on their ability to withstand the specific challenges of space travel, ensuring effective liquid containment, structural integrity, and long-term performance in a vacuum environment. In some embodiments, the container 104 comprises an internal material designed to withstand forces caused by fluid phase changes and movement, such as crystallization and expansion. The internal material may also be flexible to allow for the compression and expansion of the container 104. In some embodiments, the container 104 comprises an external material that is designed to withstand micrometeorite impacts and radiation exposure. Both internal and external materials preferably can resist temperature fluctuations and forces associated with the repeated filling and emptying of the container 104 with fluid.

A variety of materials may be incorporated into the container 104, including silicone, polyurethane, Vectran™, and Mylar, which possess low outgassing properties and compatibility with vacuum environments, reducing contamination risks in spacecraft or shared habitats. Internal layers can include polyethylene, thermoplastic elastomers (TPEs), and multilayer laminates. Polyethylene offers cryostrain resistance and flexibility, allowing it to withstand phase changes and expansion/contraction without compromising integrity. TPEs maintain elasticity across extreme temperatures and are engineered to retain structural properties despite deformations. Multilayer laminates, such as those consisting of polyethylene, aluminum, and polyamide, can provide a combination of mechanical strength, thermal insulation, and radiation shielding, making them a suitable choice for both internal and external applications. External layers may include radiation-resistant and impact-resistant materials such as boron carbide, tungsten, and lead to protect the container 104 against cosmic radiation and micrometeroid damage.

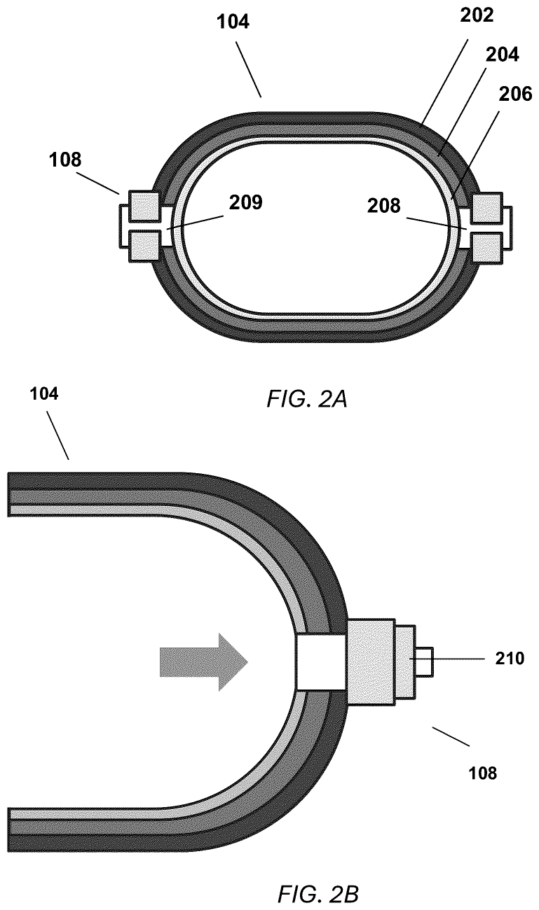

In some embodiments, the container 104 comprises at least three layers. With reference to FIG. 2A, in some embodiments the layers can comprise: 1) an outer protective layer 202 providing radiation shielding and micrometeroid protection; 2) a structural layer 204 providing tensile strength and pressure resistance; and 3) a primary bladder layer 206 providing flexibility, liquid impermeability, and thermal protection. The multi-layer construction ensures that the container 104 is sufficiently robust for long-duration space operations while remaining flexible enough to expand and contract with fluid movement. Each layer may be designed to withstand extreme temperature fluctuations, with materials selected to accommodate thermal expansion and contraction. This multi-layer approach ensures that the container 104 can reliably store and transport liquids in space while withstanding environmental hazards, thermal stresses, and fluid dynamics over extended operational lifetimes.

In some embodiments, the outer protective layer 202 is made from high-strength, impact-resistant, and/or thermally reflective materials to protect against micrometeroid impacts, radiation exposure, and extreme thermal variations in space. Suitable materials include high-performance woven silica fabrics (e.g., beta cloth, a fine silica-based fabric coated with PTFE); metalized polymer films (e.g., aluminized mylar), which can help reflect thermal radiation; and high-density polyethylene (HDPE) composites, which can provide some impact resistance and radiation shielding, or a combination thereof. For example, in one embodiment, an outer protective layer 202 of a container as described herein comprises beta cloth and aluminized mylar, and has a thickness of approximately 2-3 mm. In some embodiments, the outer protective layer 202 may also function as a thermal insulator, reducing heat loss or excessive heat absorption depending on mission requirements.

In some embodiments, the structural layer 204 provides mechanical support to withstand internal pressure changes, external forces, and expansion/contraction cycles. Suitable materials for the structural layer can include high-modulus liquid crystal polymer (LCP) fibers (e.g., Vectran™); aramid fibers, a class of strong heat-resistant synthetic fibers (e.g., Kevlar®); cross-linked polyethylene composites, which provide both mechanical support and radiation shielding; and ultra-high-molecular-weight polyethylene (UHMWPE), such as RXF1, which has excellent tensile strength and impact resistance, or a combination thereof. The structural layer 204 may also be optimized for low outgassing properties to prevent contamination in vacuum environments, particularly in compliance with NASA's ASTM E595 outgassing standard. For example, in one embodiment, a structural layer 204 of a container as described herein comprises Vectran HSHT, Kevlar, and RXF1 polyethylene, and has a thickness of approximately 4-6 mm.

In some embodiments, the primary bladder layer 206 is responsible for directly containing the liquid, maintaining impermeability, flexibility, and thermal resistance. Suitable materials for the primary bladder layer 206 can include elastomeric polymers such as silicone for high thermal stability; polyurethane or fluoropolymer coatings to ensure liquid impermeability; and thermoplastic elastomers (TPEs), which balance flexibility and durability. For example, in one embodiment, a primary bladder layer 206 of a container 104 as described herein comprises silicone and polyurethane, and has a thickness of approximately 0.5-1 mm. In some embodiments, the primary bladder layer 206 is designed to accommodate fluid expansion and contraction, ensuring structural integrity even when exposed to cryogenic or high-temperature conditions.

In some embodiments, the materials used for each layer may be tailored to specific mission requirements. For example, in cryogenic fluid transport applications, the primary bladder layer 206 may incorporate polyimide-based films (e.g., Kapton®) or aerogel-based multilayer composites for additional insulation. In high-pressure applications, the structural layer 204 may include carbon-fiber-reinforced polymers (CFRP) or high-density metalized polyethylene composites for enhanced mechanical support. For extended radiation shielding beyond low-Earth orbit (LEO), additional boron carbide layers may be integrated into the outer protective layer 202 to mitigate prolonged cosmic radiation exposure. In some embodiments, the container may also include an optional thermal layer, such as a layer of aluminized Mylar, to assist with insulation and thermal regulation.

In some embodiments, water or polyethylene layers may serve dual functions of fluid containment and radiation shielding. For example, a shielding thickness of 10 g/cm² of water can offer meaningful attenuation of galactic cosmic radiation in low Earth orbit.

In some embodiments, the container 104 is configured to store at least 1500 L of fluid, though other sizes may be used depending on mission requirements. For example, smaller systems may hold 500 L or less (e.g., 50 L, 100 L, 200 L, 300 L, 400 L) for short-term orbital missions, while larger systems may be scaled to 1000 L, 2500 L, 5000 L, 10,000 L, 25,000 L, 50,000 L, 100,000 L, or more for long-duration deep space transport or resource extraction applications. As will be described in further detail herein, multiple liquid transport systems may be interconnected to further expand the possible fluid storage capacity.

As shown in FIGS. 2A-B, the container 104 can further comprise one or more ports 208. In this embodiment, the container 104 comprises two ports 208, 209 positioned on opposite ends of the container. As will be described in more detail herein, such ports may be used by a fluid transport assembly to enable the controlled intake and release of fluid from the container 104. The use of at least two ports can further enable the system to interconnect with additional fluid transport systems, which provides modularity and the ability to efficiently transport large quantities of water in low earth orbit and beyond.

In some embodiments, the system 104 may further comprise a water treatment and filtration system to ensure the purity and safety of stored fluids, which may be integrated into the container 104 or the fluid transport assembly 108. Filtration systems may be chemical or biological, depending on the intended use. For example, chemical treatments could include chlorine-based additives or powdered disinfectants to prevent microbial growth. Biological filtration may involve materials such as zeolite, which can help remove contaminants and improve water quality. Additionally, mesh filters can be integrated at intake points to trap particulate matter before the fluid enters the container. In some embodiments, the primary bladder layer of the container 104 may be constructed from materials designed to neutralize biological contaminants (e.g., copper-infused polymers or silver-embedded materials), providing an added layer of purification for stored fluids.

iii. Fluids

In any embodiment, the container 104 may store a fluid 106. The fluid 106 can comprise a variety of liquids useful for transporting in space operations. In some embodiments, the fluid 106 is water, an important resource with applications in human consumption, agriculture, energy production, manufacturing, mining, transportation, environmental conservation, and trade. Water is essential for life support systems, including drinking, cooking, and hygiene, as well as for irrigation and hydroponic gardens, which provide oxygen regeneration and food production in closed-loop agricultural systems. Advanced controlled-environment agriculture (CEA) systems use water for nutrient delivery and plant growth, allowing space settlements to cultivate fresh produce rather than rely on Earth-based supply chains. Water collected from extraterrestrial sources, such as Enceladus' subsurface ocean, could support hydroponic systems aboard spacecraft operating in deep space. Water can also be enriched with nutrients using hydroponic (e.g., using nutrient-rich water instead of soil) and fogponic (using nutrient-rich mist) systems to improve plant growth. As space tourism expands, increased water supply will be necessary for luxury accommodations and long-term orbital habitats, requiring efficient transport and storage solutions to sustain human habitation beyond Earth.

Water is also valuable for energy production and propulsion. It can be split into hydrogen and oxygen via electrolysis, serving as a renewable fuel source for chemical propulsion systems. In electrothermal propulsion, water can be converted into plasma and expelled through thrusters (e.g., thrusters 122) for efficient deep-space maneuvering. Water can be an effective thermal management fluid, preventing overheating of spacecraft instruments and regulating habitat temperatures. Its hydrogen content also makes it an effective radiation shield, reducing cosmic radiation exposure when used as a protective barrier in crewed spacecraft and surface habitats. Additionally, in medical applications, water can be used for the treatment of radiation burns and other spaceflight-related injuries.

Water is also critical for manufacturing, resource extraction, and in-situ resource utilization (ISRU). It is widely used for cooling, cleaning, lubricating, and as a 3D printing medium in microgravity. In-space manufacturing operations, such as those aboard the International Space Station (ISS) or future lunar and Martian colonies, rely on water for chemical processing, material synthesis, and thermal management. In mining and ISRU, water can be used for drilling, dust suppression, cooling equipment, and processing extracted materials. Water harvested from asteroids, lunar ice deposits, or Martian subsurface reservoirs can be refined, stored, and transported to support off-world industrialization, reducing dependence on Earth-based resupply missions. The ability to transport large quantities of water efficiently is essential for long-term space exploration, industrial expansion, and the development of a sustainable interplanetary economy.

In some embodiments, the fluid 106 is an oil, such as seed oil, coconut oil, canola oil, petroleum, mineral oil, or synthetic lubricants, each with applications in thermal management, lubrication, industrial processing, and life support systems. Oils can be used in cooling systems, such as those for data centers, space-based computing systems, and high-power electronics, where their high thermal capacity and low volatility enable efficient heat dissipation in closed-loop thermal management systems. Oils also serve as lubricants in space applications, reducing friction in robotic systems, actuators, and spacecraft docking mechanisms, where traditional lubricants may degrade in vacuum environments. In mining and resource extraction, oils may function as hydraulic fluids for drilling operations, dust suppression, and machinery cooling, particularly in abrasive extraterrestrial environments. Oils can also serve as reaction media for chemical processing, supporting fuel synthesis, polymer production, and in-situ manufacturing. Additionally, edible oils such as canola, sunflower, omega-3, and coconut oil are essential for food production, storage, and nutrition in long-duration space missions, serving as caloric energy sources, cooking ingredients, and food preservatives. The ability to transport and store oils efficiently expands their use across scientific, industrial, and life support applications in space.

In some embodiments, the fluid 106 is hydrogen, which can be derived from water via electrolysis and used as a liquid fuel source for energy production in fuel cells and rocket propulsion systems. Though hydrogen exists as a gas at standard temperature and pressure (STP), it is commonly stored and transported in its liquid form in space applications, such as liquid hydrogen (LH₂) for rocket fuel and cryogenic energy storage. Embodiments of liquid transport systems as described herein can enable efficient containment and transfer of liquid hydrogen, maintaining the necessary low temperatures and controlled pressure to prevent unwanted boil-off or phase transitions. In other embodiments, the fluid 106 is oxygen, which can also be derived from water electrolysis and stored in liquid form for space applications. Liquid oxygen (LOX) is widely used in life support systems for breathable air and as an oxidizer in propulsion systems. As with hydrogen, the ability to store, transport, and transfer oxygen in its liquid state allows for greater efficiency and scalability in space-based fuel depots, life support modules, and deep-space exploration missions.

In other embodiments, the fluid 106 can be an alcohol, an acid, a base, or a liquid metal such as mercury, each with applications in fuel systems, chemical processing, and industrial operations. Alcohols, such as methanol or ethanol, can serve as fuels or solvents in space-based energy and life support systems. Acids and bases, including sulfuric acid, nitric acid, and ammonia-based solutions, may be used in chemical synthesis, refining, and in-situ resource utilization (ISRU). Liquid metals, such as mercury, gallium, or sodium-potassium (NaK) alloys, have applications in cooling systems, electrical conductivity, and advanced propulsion. The liquid transport system described herein allows for the safe storage, transfer, and use of these fluids in space environments.

iv. Fluid Transport Assembly

In some embodiments, the system further comprises a fluid transport assembly 108 coupled to the container 104. The fluid transport assembly 108 is configured to allow easy connection and disconnection for fluid intake or dispensing, including during orbital servicing or in-space refueling operations. In some embodiments, standard interface locations may facilitate manual or automated docking procedures. For example, the fluid transport assembly 108 may incorporate standardized interfaces such as NASA quick-disconnect fittings or compatible commercial fluid connectors, enabling integration with existing spacecraft systems or third-party payloads.

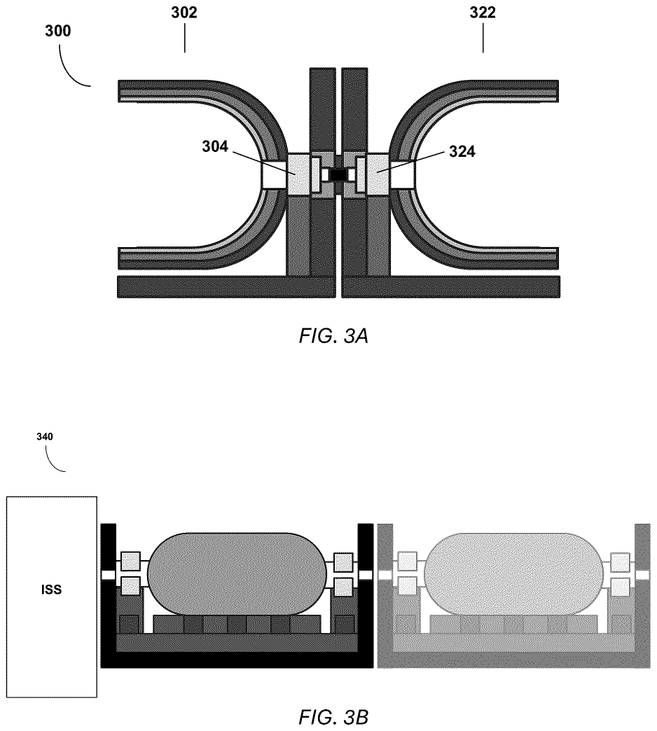

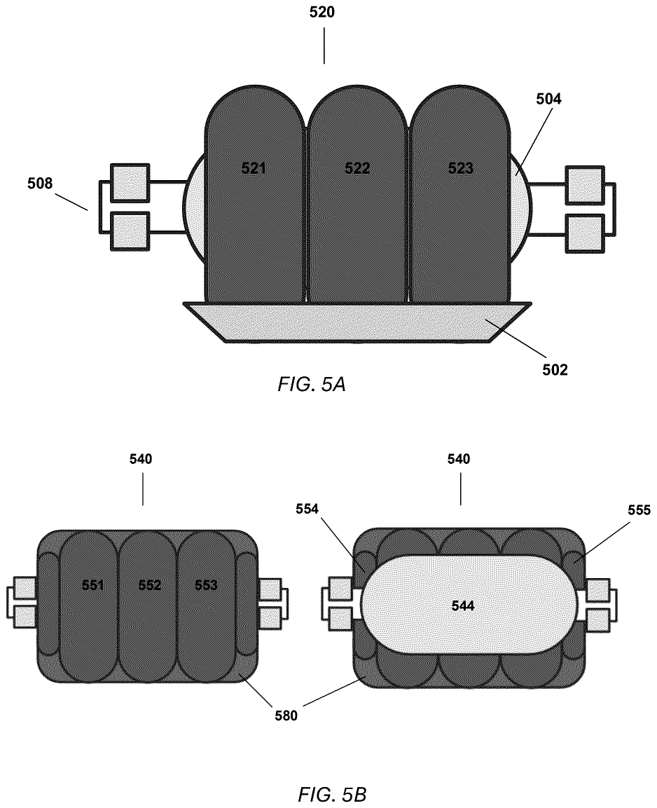

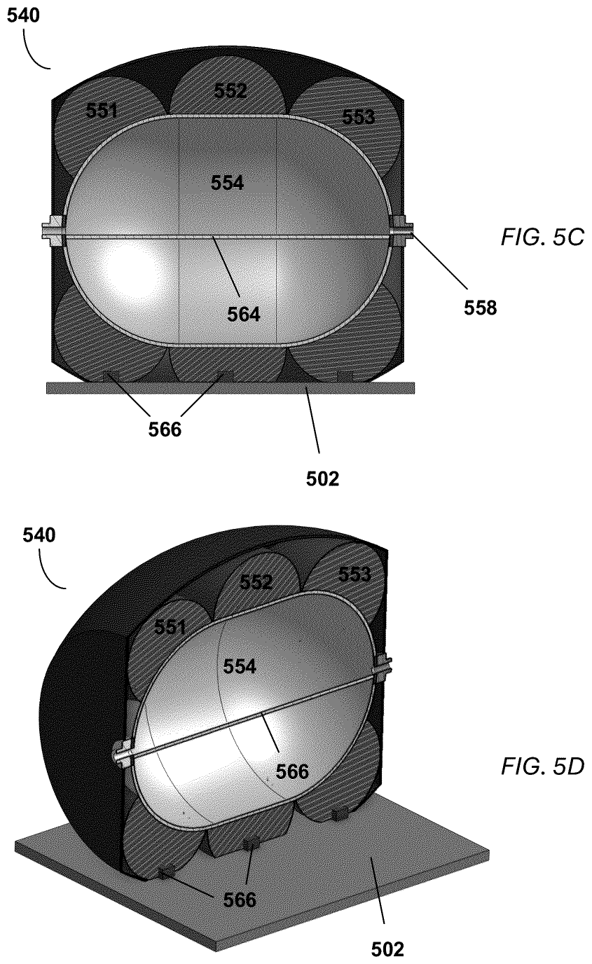

As shown in FIGS. 2A-B, the fluid transport assembly 108 can include one or more ports or openings in the container 104, which can be coupled to a valve 210 or similar fluid control mechanism to enable controlled intake and release of fluid. In some embodiments, the fluid transport assembly 108 can comprise two ports (such as the ports 208, 209) positioned at opposite ends of the container, each coupled to a valve or similar fluid control mechanism (e.g., as shown in the embodiments of FIG. 3B and FIG. 5A). The use of dual valves positioned at opposite ends of the container can serve as designated entry and exit points for the fluid 106.

The valve 210 can take various forms depending on operational needs. The valve 210 may be mechanically actuated, electrically controlled, acoustic-regulated, or pressure-regulated, depending on mission requirements. For example, as shown in the embodiment of FIG. 5B and described in further detail herein, the valve can be an inflatable bladder that, when sufficiently inflated, pinches the port 208 closed. In some embodiments, the valve 210 may be a ball valve, gate valve, butterfly valve, solenoid valve, or needle valve, each offering different advantages based on flow control precision, actuation speed, and sealing efficiency. For example, a ball valve can provide quick shutoff, while a needle valve allows for fine-tuned fluid control. A solenoid valve can be electrically actuated, making it suitable for automated system operation.

In some embodiments, the valve 210 may be configured as an inter-module connector, directly enabling fluid transfer between interconnected systems without requiring additional components. In such configurations, the valve 210 may comprise quick-connect couplings, docking collars, or adaptive latching mechanisms, allowing for secure and leak-proof connections between multiple containers or fluid transport networks. Alternatively, in other embodiments, an inter-module connector may be a separate component coupled to the valve 210, providing additional flexibility for modular system integration.

The fluid transport assembly 108 may also include a mating interface, which can be passive or active, to support modular fluid transfer between interconnected systems. The valve 210 can be configured to facilitate fluid exchange, system purging, pressure equalization, or controlled dispensing, depending on operational needs. The mating interface can be designed to support both proprietary and standardized connection systems, ensuring compatibility with various fluid transport architectures, including refueling depots, in-space fluid recycling systems, and spacecraft liquid reservoirs (e.g., aboard the International Space Station).

In some embodiments, the fluid transport assembly 108 includes an electric pump that provides active control over fluid intake or dispensing. The pump may be particularly useful in situations where the fluid 106 must be transferred against external pressure, the pressure control system 112 provides only passive pressure, and/or when transporting viscous or temperature-sensitive fluids.

In some embodiments, the fluid transport assembly 108 may be configured to dispense fluid in a specific direction, thereby generating reactive thrust. This may enable limited maneuvering, station-keeping, or orientation control using water or other fluids as propellant.

v. Modularity

Liquid transport systems as described herein can be modular and thus can be interconnected to enable scalable fluid transfer and storage capabilities. These interconnections can be established through the frame 102 and/or the fluid transport assembly 108, depending on structural and operational requirements. Frame-based connections provide stability and rigidity, reinforcing mechanical support when multiple systems are joined together. Fluid transport assembly connections enable direct fluid transfer between interconnected units. In some embodiments, both the frame and fluid transport assembly are connected, while in others, only one type of connection is used, depending on mission requirements.

FIG. 3A depicts one embodiment of a fluid transfer network 300. As shown, the fluid transport network 300 can comprise one or more liquid transport systems, such as a first liquid transport system 302 and a second liquid transport system 322. Each of the liquid transport systems 302, 322 include an inter-module connector (e.g., valves 304, 324), allowing them to be selectively connected or disconnected to one another as needed. The valves 304, 324 within each system can be actuated to transfer liquid between the interconnected systems (e.g., if the liquids are the same), or they may remain closed, allowing each unit to operate independently (e.g., if the liquids are different). In some embodiments, liquid transport systems may include two or more inter-module connectors, such as those positioned on proximal and distal ends of the container 104, allowing multiple systems to be linked together in a continuous chain, e.g. as further shown in FIG. 3B. This modular interconnected configuration, which may be referred to herein as a fluid transfer network, enables scalable liquid transport across multiple interconnected units. For example, as shown in FIG. 3B, a fluid transfer network 340 can comprise multiple liquid transport systems, with one termination point docked to a fixed structure, such as the International Space Station (ISS), a fuel depot, or another spacecraft, to deposit or retrieve liquid as needed.

The modular nature of the system allows for configurations ranging from small-scale deployments to large-scale fluid storage and distribution networks. Multiple interconnected systems can accommodate virtually any required quantity of liquid, enabling storage and transport of, e.g., 500 L, 1000 L, 1500 L, 3000 L, 5000 L, 10000 L, 100000 L, 1000000 L, or more, depending on mission parameters. For example, a small utility storage tank on a small zero-G data center may require only 100-3,000 L, whereas a colonial sized shipment from Enceladus may require in excess of 100000 L. This scalability and adaptability provide an efficient solution for space-based fluid logistics, including water distribution, fuel storage, scientific research, and in-orbit refueling. For example, in some embodiments, a fluid transfer network comprises 2, 3, 4, 5, 6, 7, 8, 9, 10, or more interconnected liquid transport systems.

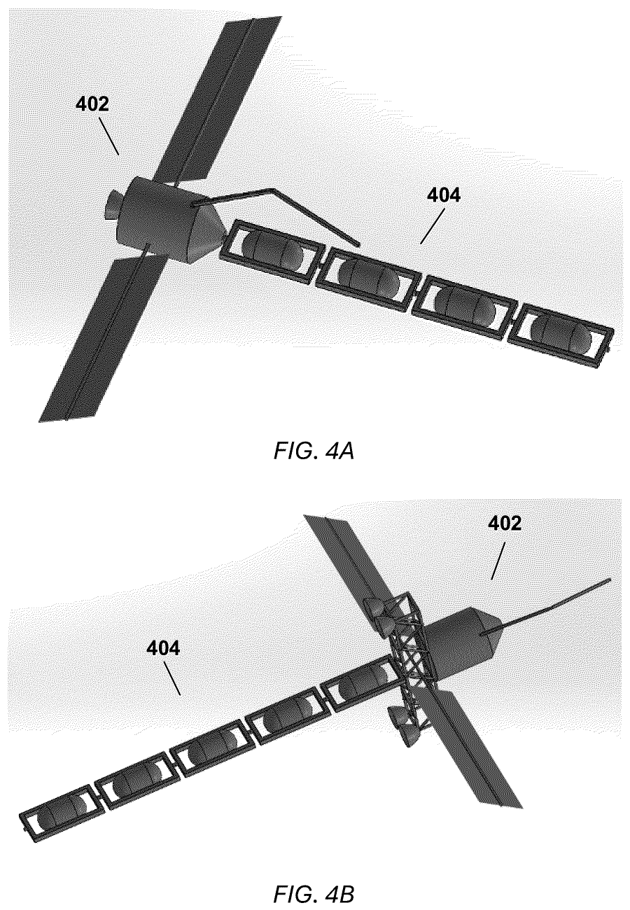

Such modular systems are well suited for flexible deployment and repositioning within Low Earth Orbit (LEO) and beyond. As shown in FIGS. 4A-4B, a fluid transfer network 404 comprising multiple modular liquid transport systems can be maneuvered using autonomous or crewed transport vehicles, such as Autonomous Logistics Vehicles (ALVs) 402, space tugs, or other orbital maneuvering systems. These vehicles provide a means to reposition, deliver, or retrieve liquid transport modules, enabling efficient fluid resupply, in-space refueling, and station-keeping operations.

Modular systems such as system 100 are particularly well-suited for orbital logistics, as they allow for scalable fluid transport and storage without requiring a single large monolithic structure. In some embodiments, multiple liquid transport systems may be linked together in a chain-like configuration, where an external vehicle can either pull or push the interconnected modules to new locations. As shown in FIG. 4A, a transport vehicle may pull a set of interconnected liquid transport modules (the fluid transfer network 404), while in FIG. 4B, a transport vehicle may push the modules from behind. The modular design allows for independent or group-based maneuvering, enabling transport systems to be repositioned individually or as part of a larger logistics network.

Transport vehicles used for maneuvering modular liquid transport systems may include chemical or electric propulsion systems, such as Hall-effect thrusters, ion propulsion, or traditional monopropellant engines, depending on mission requirements. These vehicles may also include docking interfaces that attach to the frame 102 or fluid transport assembly 108, providing both structural support and fluid transfer capabilities when docked to a space station, fuel depot, or servicing platform.

The ability to autonomously or semi-autonomously reposition modular liquid transport units provides a scalable and cost-effective approach to in-space resource management. Whether used for delivering water to space stations, transferring cryogenic fuels for satellite refueling, or supporting long-duration space habitats, modular fluid transport systems as described herein enable adaptable, reusable, and efficient fluid logistics for a wide range of space applications.

vi. Sensor Array

The system 100 can further comprise one or more sensors 110, which can include a variety of internal and external sensors to monitor fluid conditions, environmental parameters, and system performance. Internal sensors may include pH sensors, temperature sensors, pressure sensors, radiation sensors, and conductivity sensors, which may continuously assess the quality, stability, and safety of the fluid 106 stored within the container 104. For example, pH sensors can detect acidity or alkalinity shifts in stored water or chemical fluids, while temperature and pressure sensors ensure that cryogenic fluids or volatile liquids remain within safe operating thresholds. In some embodiments, radiation sensors can detect exposure levels for fluids used as shielding materials, conductivity sensors can be used to assess electrolyte content or fluid purity, and fluid level monitors can track the volume of fluid currently being stored.

In addition to internal monitoring, the sensors 110 may also include external sensors for spatial awareness, navigation, and situational monitoring. For example, optical cameras, infrared sensors, star trackers, and LiDAR can provide visual and positional data to assist in autonomous docking, inter-module alignment, or orbital navigation. Environmental sensors may detect solar radiation intensity, cosmic ray exposure, or micrometeoroid impact events, ensuring the system can respond dynamically to external conditions.

The sensors 110 are in electronic communication with the controller 116, allowing the system to operate in a fully automated or semi-autonomous manner. When sensor readings indicate a change in conditions, the controller 116 can engage the appropriate subsystems, including the temperature control system 114, pressure control system 112, filtration system, fluid transport assembly 108, and/or thrusters 122. For instance, if a pressure sensor detects a drop below a defined threshold, the controller may activate the pressure control system 112 to apply additional force to maintain the liquid in a stable state. Similarly, if temperature sensors indicate a risk of freezing, the temperature control system 114 may engage active heating elements to regulate fluid temperature. In some embodiments, the system may also include fail-safes or redundancy mechanisms, wherein multiple sensors cross-verify readings to prevent faulty data from triggering unnecessary actions. This network of sensors enables the liquid transport system to function with greater autonomy, adaptability, and efficiency, ensuring that fluids remain stable, secure, and accessible even in variable or extreme space conditions.

In some embodiments, the system 100 includes sensors configured to detect leaks or ruptures in the container 104. These may include pressure drop sensors or fluid presence sensors positioned near the fluid transport assembly 108, enabling automated fault detection and containment protocols.

vii. Temperature Control System

In one embodiment, the temperature control system 114 comprises an active heating system, such as a heating element positioned within the container 104. The heating element can respond to temperature changes detected by the sensors 110 via the controller 116 to increase the temperature of the fluid 106 to prevent freezing. The heating element can comprise a resistive heater, an inductive heater, a fluid-based heat exchanger, a radioisotope heating unit (RHU), or a combination thereof, depending on mission requirements. In some embodiments, the temperature control system 114 can comprise a passive heating system, e.g., by rotating the system 100 to ensure that solar radiation is evenly distributed across the container 104. In another embodiment, the temperature control system 114 comprises a dome or shield that covers the container 104. In such embodiments, the temperature can be increased by opening the dome or shield to allow solar radiation to pass through and heat the container.

In one embodiment, the temperature control system 114 comprises an active heating system, such as a heating element positioned within the container 104. The heating element can respond to temperature changes detected by sensors 110 and be controlled by the controller 116 to increase the temperature of the fluid 106 and prevent freezing. The heating element may comprise a resistive heater, inductive heater, fluid-based heat exchanger, radioisotope heating unit (RHU), or a combination thereof, depending on mission requirements and available power. For example, in the embodiment of FIGS. 5C-D, the temperature control system 114 comprises an elongated heating element 512 positioned longitudinally within the center of the container 104. The heating element 512 may extend from one end of the container to the other, providing uniform, radiative heating throughout the volume of fluid 106. This centrally located configuration facilitates even heat distribution in microgravity environments where convection is limited and may be especially useful for large or high-volume containers. In other embodiments, the temperature control system 114 comprises a passive heating approach, such as rotating the system 100 to ensure even exposure to solar radiation across the container 104. In another embodiment, the system includes a solar-heating dome or shield that partially or fully encloses the container 104. In such embodiments, the dome or shield may be selectively opened or oriented to allow solar radiation to heat the container.

In some embodiments, when the fluid is water, the temperature control system 114 is configured to maintain the fluid between approximately 10° C. and 95° C. In some embodiments, when the fluid is an oil (e.g., seed oil, sunflower, omega-3, coconut oil, canola oil, petroleum, mineral oil, or synthetic lubricants), the temperature control system 114 is configured to maintain the fluid between approximately −40° C. and 350° C. Maintaining these temperature ranges can prevent freezing or boiling under anticipated pressure conditions during orbital or deep-space operation.

In some embodiments, the system 100 may be configured for use in missions extending beyond Earth orbit, including to distances of up to 5 AU from the Sun. In these embodiments, the temperature control system 114 may be supplemented with insulation or radioisotope heating units to accommodate colder thermal environments encountered at these distances.

viii. Power Sources, Controllers, and Maneuvering

The controller 116 may comprise a computer system that includes a processor and memory, and may be configured to execute instructions for operating one or more components of the liquid transport system 100. In some embodiments, the controller 116 is communicatively coupled to other subsystems, such as the pressure control system 112, temperature control system 114, fluid transport assembly 108, sensors 110, and thrusters 122 via wired connections (e.g., Ethernet, CAN bus, or serial interface) or wireless protocols. The controller 116 may be programmed to enable automated or semi-autonomous operation, including logic for maintaining the fluid 106 in a liquid state, managing energy use, and handling sensor feedback. In some embodiments, the controller 116 may be implemented using a space-rated embedded computing platform, such as those provided by Pumpkin Space Systems, or other commercially available flight computers.

In some embodiments, the controller 116 may include automated diagnostic routines that continuously monitor system status from (e.g.) the sensors, including temperature, pressure, fluid levels, and valve operation. Alerts or adjustments may be triggered autonomously based on predefined thresholds. In some embodiments, the system 100 may include visual or audible indicators (e.g., LEDs or buzzer alarms) that provide real-time fault alerts in response to sensor-detected anomalies, supporting crewed or remote operations.

The battery 118 may comprise a rechargeable battery module configured to store and supply electrical power to one or more components of the system 100. In some embodiments, the battery 118 includes an integrated battery management system (BMS) capable of monitoring state of charge (SoC), temperature, voltage, and health metrics. The battery module may be located within the frame 102 or positioned externally, and can be designed for thermal resilience, radiation tolerance, and modular replacement. The battery 118 can supply power to the controller 116, temperature and pressure control systems, and other subsystems during eclipse periods or when the primary power source is unavailable.

The power source 120 may comprise a solar panel, such as a deployable solar array, configured to harvest solar energy and convert it into electrical power for system operation and battery charging. In some embodiments, the solar panel 120 is mounted on or integrated with the frame 102 and can include articulating or folding mechanisms to optimize surface area and energy absorption while minimizing launch volume. The solar panel 120 may interface with a power management system that regulates current flow to the battery 118 and other onboard components, enabling continuous operation in sunlight-rich orbital paths or low-Earth orbit (LEO) missions.

The thrusters 122 may comprise one or more propulsion units configured to enable attitude control, repositioning, or station-keeping of the system 100 in a space environment. In some embodiments, the thrusters 122 may use electrothermal or electric propulsion systems, such as Hall-effect thrusters, resistojets, or ion thrusters, and may be configured to operate using water or other fluids stored within the container 104 as propellant. The thrusters 122 may be controlled by the controller 116 based on input from navigation sensors or ground-based commands, allowing for precise maneuvering of individual or interconnected systems. In some embodiments, the thrusters may support limited orbital transfers or rendezvous operations with other spacecraft or fluid depots.

In one embodiment, the thrusters 122 can comprise 1, 2, 3, or more thrusters to control the attitude, speed, and rotation of the system 100. In some embodiments, the thrusters 122 use the fluid (e.g., water) from the container 104 to supply thrust. In such embodiments, the thrusters convert the water to a plasma which is then expelled from the thruster to maneuver the system. This conversion may involve heating the water to vaporize it, followed by ionizing the vapor into plasma using microwave, RF, or direct electric discharge techniques. The plasma is then accelerated via electromagnetic or electrostatic fields and expelled through the thruster nozzle to generate thrust. In other embodiments, the thrusters do not convert the water to plasma, but instead eject it as a gas or steam to provide thrust. Systems according to the disclosure can incorporate at least one thruster to provide basic maneuverability and six or more thrusters for full attitude control in space.

ix. Pressure Control System

Multiple pressure control systems are disclosed herein, each providing a means to maintain sufficient internal pressure within the container 104 to preserve the fluid 106 in a liquid state in a vacuum environment. The choice of pressure control configuration may depend on mission objectives, environmental conditions, mechanical complexity, redundancy needs, and the properties of the fluid being transported. The following provides a comparative overview of the disclosed embodiments.

In some embodiments, the pressure control system comprises one or more inflatable donuts, which are circumferential bladders that surround the container 104. This configuration enables uniform pressure application and allows for modularity, redundancy, and simple inflation-based control. Donuts may be independently inflated or deflated to adjust pressure distribution, and their lightweight, flexible design is well suited to volume-constrained payloads. This embodiment is particularly useful in resupply missions or short-duration deployments where simplicity and reliability are prioritized.

In other embodiments, the system employs a dual-bag configuration, in which a gas-inflated secondary containment bag envelops the container 104. This design creates a fully enclosed pressure environment and may offer greater resistance to micrometeoroid impacts or environmental exposure. The dual-bag system is especially advantageous when redundant containment, environmental shielding, or uniform full-surface compression is desired, such as in deep-space or long-duration missions.

In a third embodiment, the pressure control system comprises a set of high-strength belts or straps that encircle the container 104 and can be tensioned via motorized pulley systems. The strap-based approach provides precise, directional pressure control without relying on stored gas, and the belts can also serve a dual role as structural anchoring elements. This configuration may be preferred in applications requiring rigid integration with a frame, or where fine-tuned pressure modulation is beneficial, such as in sensitive scientific experiments or varying-gravity environments.

In yet another embodiment, the pressure control system includes a semi-rigid lattice structure that surrounds the container 104 and constricts upon actuation. The lattice may be formed from interconnected struts that maintain flexibility while offering mechanical strength and reusability. Tension applied through an expandable arm or similar actuator causes the lattice to compress radially. This configuration allows for distributed pressure application without inflation systems or motors and may be beneficial in missions where durability, simplicity, or long-term deployment is critical.

Each pressure control system may be selected or customized based on mission parameters. For example, donut-based systems may be optimal for low-power, short-duration orbital transfers; dual-bag systems may be best for high-value or cryogenic fluids where redundant containment is required; strap-based systems may serve well in precision-controlled, modular deployments with integrated structural needs; and lattice-based systems may be most appropriate for reusable platforms or where mechanical simplicity and no-gas operation are advantageous. While the specific choice of pressure control system may vary, each embodiment is capable of supporting the broader goals of scalable, modular, and reliable fluid transport in space environments. In some configurations, pressure control components may also be hybridized or combined to offer tailored performance for specific operational requirements.

In some embodiments, the pressure control system is configured to maintain an internal pressure of at least 0.0425 bar. For example, when the fluid is water, maintaining a pressure above this threshold helps preserve the liquid state in a vacuum environment, particularly near 30° C., which corresponds to the approximate vapor pressure of water at that temperature. In other embodiments, higher pressures may be used for fluids with greater volatility or higher vapor pressures. Depending on the fluid type, mission parameters, and operational temperature, the pressure control system may be configured to maintain an internal pressure ranging from approximately 0.01 bar to 4.05 bar (i.e., 0 to 4 atmospheres). This range enables compatibility with a variety of fluids, including water, oils, cryogenic fuels, or pressurized propellants, and supports use cases where elevated pressure may assist in driving fluid through valves or enabling thrust.

a. Inflatable Tube Pressure Control System

In some embodiments, a pressure control system 112 can comprise one or more circular inflatable tubes or bladders, herein referred to as “donuts,” which surround the expandable container 104 and can be inflated to apply external pressure, thereby maintaining an internal pressure sufficient to keep the fluid 106 in a liquid state in a vacuum environment. In some embodiments, the pressure control system 112 includes one, two, three, or more donuts, which can be independently or collectively inflated or deflated to modulate pressure as needed. The donuts can be positioned in series around the container 104, so that most or all of the container is enclosed, allowing for uniform and targeted pressure application. When inflated (e.g., by injecting a pressurized gas or air into their volume), the increasing volume of the donuts compresses the container 104, increasing its internal pressure. Additionally, the pressure applied by the donuts can be used to direct the fluid 106 toward one or more open valves, thereby assisting in fluid transport through the fluid transport assembly 108.

FIGS. 5A-D depict embodiments of exemplary inflatable tube pressure control systems according to the disclosure. As shown in the embodiment of FIG. 5A, a pressure control system 500 can comprise three donuts 521-523, which may be affixed to a frame 502 and positioned around a container 504. When inflated, the donuts apply sufficient pressure to maintain the desired internal pressure in the container 504. In some embodiments, inflation of the donuts 521-523 can be individually controlled, for example, to facilitate fluid movement through a fluid transport assembly 508. This is particularly useful in zero-G environments where the fluid requires assistance to be moved from one direction to another, e.g., by selectively applying pressure at one end of the container. Further, as shown in the embodiment of FIG. 5B, a pressure control system 540 having three donuts 551-553 can further comprise one or more “pinch-off” donuts 554-555, also referred to as a sphincter mechanism, which may be located at or near the one or more valves of the container. Selective inflation of either pinch-off donut 554-555 causes it to expand and constrict the valve opening, allowing the system to prevent unintentional fluid release or to enable controlled fluid dispensing.

As shown in the embodiments of FIGS. 5B-D, both a container 544 and pressure control system may be enclosed within a secondary containment bag 580, which can provide backup pressure stabilization in the event of a failure or pressure loss in the primary system. The secondary containment bag 580 may fully enclose the container 544 and may include an outer protective layer (such as the outer layer 202 described with reference to FIG. 2A herein), to shield the entire system from radiation, thermal variation, and micrometeoroid impacts. In such embodiments, the container 544 includes at least one gas-impermeable layer to ensure that the liquid remains properly contained, typically achieved by the first (primary bladder) layer. This layer provides flexibility and liquid impermeability and contains the fluid during pressure fluctuations. The third (outermost) layer of the container 544 interfaces with the inflatable elements and must be capable of withstanding frictional wear caused by repeated expansion and contraction of the donuts. While this third layer may be gas-impermeable for redundancy, it is not required to be, as long as the inner containment is maintained. The secondary containment bag 580 may also include a gas-impermeable layer to provide backup containment in the event of a rupture or leak in either the container 544 or the inflatable elements. In such embodiments, the containment bag provides both structural resistance and serves as a pressure-transmitting surface against which the inflatable donuts can apply uniform compressive force to the container.

Accordingly, in such embodiments, the container 544 may include at least: (1) a primary bladder layer that holds a fluid, ensures flexibility and impermeability, and is gas-impermeable, e.g., by use of a gas-impermeable surface or coating; (2) a structural layer that provides tensile strength and pressure resistance; and (3) an outer resistive layer that interfaces with the surrounding inflatable elements and is configured to withstand continuous mechanical contact, abrasion, and localized force during inflation and deflation cycles. Similarly, each donut in the pressure control system 540 may comprise a gas-impermeable inner layer to retain the inflation medium and an optional outer layer for environmental protection or abrasion resistance. Together, these elements work in concert to deliver controlled, uniform pressure to the container while ensuring redundancy and structural integrity across a variety of mission scenarios.

In some embodiments, the donuts may be inflated using a pressurized gas, such as nitrogen, helium, carbon dioxide, or another inert or non-reactive gas suitable for space applications. Thus, in such embodiments, a liquid transport system may include one or more gas storage tanks integrated into or mounted on the frame (e.g., positioned beneath or adjacent to the donuts), which can supply inflation medium to the donuts through valves and flexible tubing. Such Inflation and deflation operations may be managed by small onboard pumps, gas regulators, or solenoid valves controlled by the controller in response to pressure sensor readings. In some embodiments, the inflation system may support partial or selective inflation, allowing individual donuts to be engaged or disengaged as needed to fine-tune internal pressure or accommodate dynamic conditions such as fluid volume changes or thermal expansion. Redundant tanks or pressure relief systems may also be included to ensure safe and reliable inflation management throughout the system's operational life. In certain embodiments, the donuts remain inflated even when the container is empty, to retain structural integrity or preserve readiness.

As shown in FIGS. 5C-D, in some embodiments, each of the donuts 551-553 may be affixed to the frame 502 at one or more connection points 566. Various attachment mechanisms may be used depending on material compatibility, deployment requirements, and structural loads. In some embodiments, the donuts may be connected via webbing loops or textile straps sewn or bonded to the bladder exterior and anchored to hooks, cleats, or hardpoints on the frame. In other embodiments, the donuts may be affixed using releasable clamps, compression collars, or flexible mounting rails integrated into the frame geometry. For rigid or semi-rigid frame structures, bolt-through grommets or snap-fit retention clips may be used to secure the inflatable tubes at defined intervals. In some embodiments, the donuts may be encased in segmented sleeves that slide into track-based guides or are laced into the frame using high-strength tethering materials. These mounting configurations ensure the donuts remain properly positioned to apply uniform pressure while maintaining alignment during inflation, deflation, or launch vibration.

b. Dual-Bag Pressure Control System

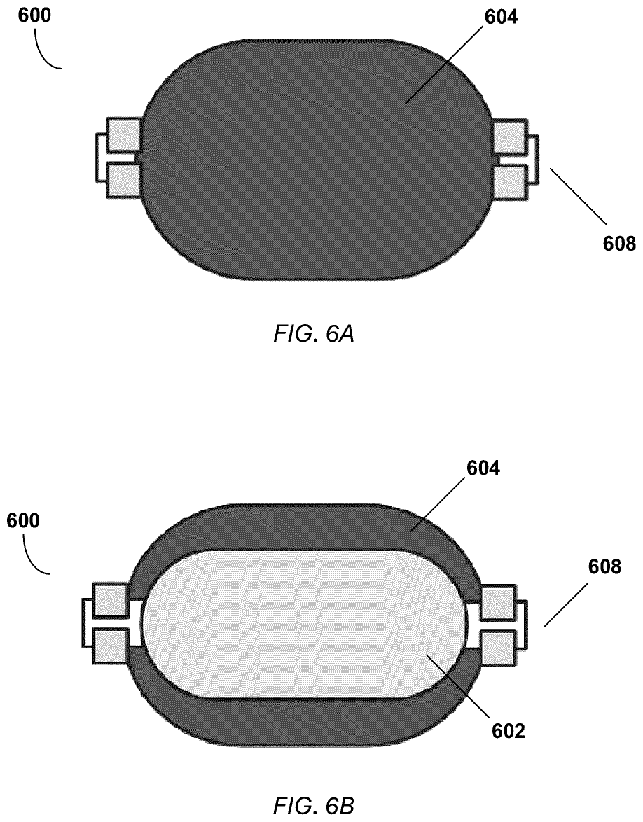

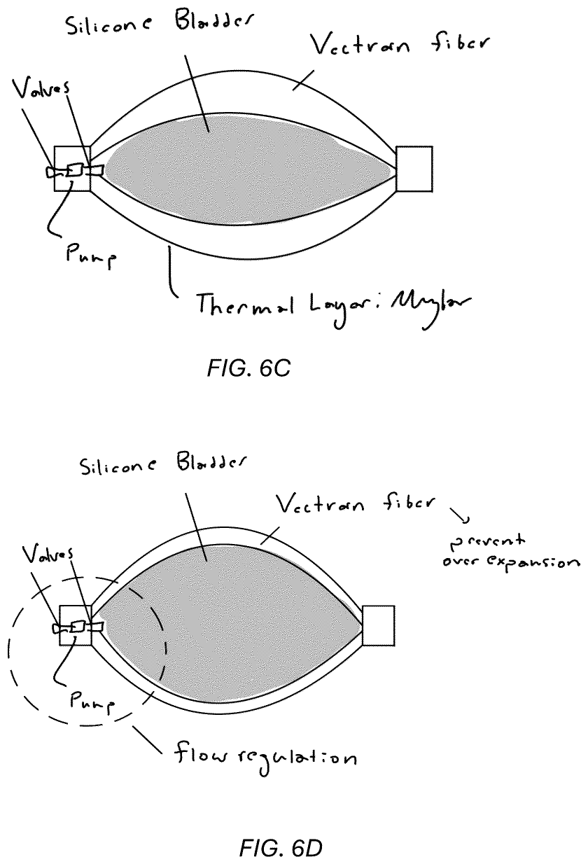

With reference to FIGS. 6A-6B, another embodiment of a pressure control system is shown, referred to herein as a dual-bag system 600. In this embodiment, the container 602—a flexible, expandable internal bag configured to store a fluid, as described herein—is enclosed within a secondary containment bag 604, forming a bag-inside-a-bag configuration. The secondary containment bag 604 surrounds the container 602 on all sides, except at the entry and exit points for fluid transfer, allowing access to a fluid transport assembly 608. When the secondary containment bag 604 is inflated, e.g., by forcing a gas into its internal volume, it expands and applies external pressure to the container 602, thereby increasing internal pressure within the container and maintaining the fluid in a liquid state. As with some other embodiments of pressure control systems described herein, the inflation of the secondary containment bag 604 can also be used to drive fluid toward one or more valves, facilitating fluid movement through a fluid transport assembly 608. This approach provides a uniform and fully enclosing pressure application, potentially simplifying structural alignment compared to donut-based systems. Thus, this dual-bag configuration provides a robust, redundant structure for both containment and pressure control, and may be particularly useful in applications where full enclosure, mass efficiency, and even pressure distribution are prioritized.

In this embodiment, the container 602 may comprise at least (1) a primary bladder layer to directly contain the fluid, (2) a structural layer for pressure resistance and durability, and (3) an outer gas-impermeable surface or coating to interact effectively with the surrounding inflated volume. The secondary containment bag 604 may similarly comprise (1) an inner gas-impermeable layer to contain the inflation medium, and (2) an outer protective layer similar to outer layer 202, configured to withstand micrometeoroid impacts, thermal variation, and radiation. In some embodiments, the outer layer may be flexible or reinforced, depending on mission requirements and deployment constraints.

In an alternative embodiment of the dual-bag configuration, as shown in FIGS. 6C-6D, the secondary containment bag 604 is not inflated but instead comprises a mechanically constrictive material that resists expansion. In this embodiment, the outer bag is formed from a high-tensile, low-flexibility material such as Vectran™ fiber, another liquid crystal polymer (LCP) material, or even a non-synthetic constrictive material such as leather or animal hide, which naturally limits volumetric expansion and provides sufficient mechanical resistance to compress the internal container 602 as fluid is introduced. The outer bag may also include an optional thermal layer, such as a layer of aluminized Mylar, to assist with insulation and thermal regulation. The container 602 in this embodiment includes at least two layers-a primary bladder layer (e.g., silicone) to hold the fluid and a structural support layer for pressure and shape stability.

Because the outer bag provides pressure passively via its inherent material properties, no gas inflation system is required. As a result, the fluid transport assembly 608 may include additional active components, such as a pump or actuator, to overcome the external compression and enable controlled fluid intake and dispensing. This mechanically constrictive configuration provides a compact, non-inflatable solution for pressure regulation and may be especially useful in missions where gas storage is limited, or where mechanical simplicity and mass efficiency are prioritized over adjustability. The rigid or semi-rigid nature of the outer bag also offers enhanced protection and structural support, reducing the need for external framing or reinforcement during transport and deployment.

In some embodiments, the secondary containment bag 580 provides a redundant barrier that functions as a backup containment structure in the event of damage or failure in the primary bladder layer of the container 104.

c. Strap-Based Pressure Control System

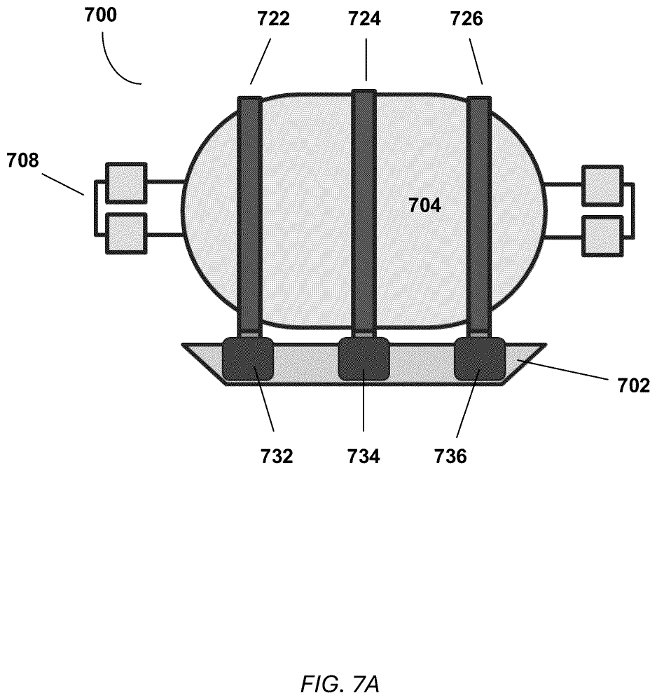

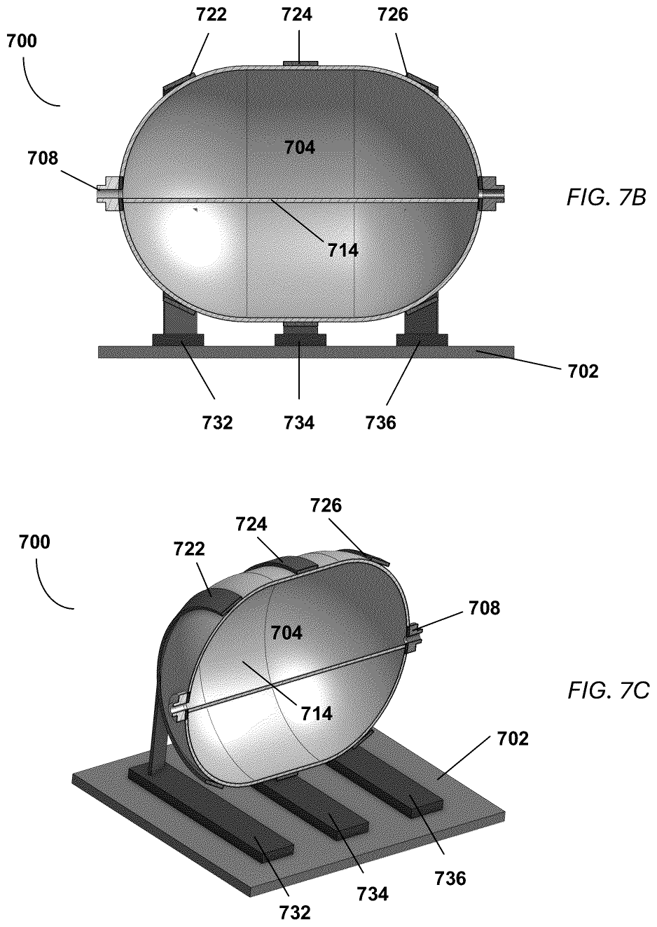

With reference to FIGS. 7A-7C, another embodiment of a pressure control system is shown, referred to herein as a strap-based pressure control system 700. In this embodiment, a container 704 comprises a flexible, collapsible tank that is surrounded by a series of belts or straps 722, 724, 726, which are positioned circumferentially around the container. The straps may be constructed from nylon, Vectran, Kevlar, or other high-tensile strength materials, and each strap may be independently operable. In this embodiment, each strap is coupled to a corresponding strap motor 732, 734, 736, which can be used to tighten or loosen the strap as needed. This strap-based system provides a compact and mechanically simple alternative to inflatable systems, and may be preferred in missions where active mechanical control, low gas storage, or integration with rigid structures is desired.

When the strap motors are engaged to tighten the straps, the belts apply a constrictive force around the container 704, compressing its volume and thereby increasing internal pressure. This pressure is sufficient to maintain the fluid within the container 704 in a liquid state in a vacuum environment, and also to direct the fluid towards the fluid transport assembly 708, allowing for controlled dispensing through an open valve. Because the belts can be independently actuated, the pressure control system 700 allows for fine-tuned control over pressure application along different regions of the container. Similar to the previously described donut-based system, selective pressure applied by the straps to one end of the container can be used to move fluid from one direction of the container to the other.

As shown in this embodiment, the straps 722, 724, 726 can also anchor the container 704 to the frame 702, providing both mechanical support and load distribution during launch, maneuvering, or fluid transfer. The container 704 in this embodiment may include the previously described three-layer construction, comprising: (1) a primary bladder layer for fluid containment, providing flexibility and liquid impermeability, and serving as a gas-impermeable layer needed for pressure containment; (2) a structural layer to provide tensile strength and resistance during strap contraction; and (3) an outer resistive layer configured to withstand repeated contact and friction from the surrounding straps 722, 724, 726. While the outer layer may optionally be gas-impermeable, it is not required to be, as long as the inner bladder maintains containment. In some embodiments, the container 704 further comprises a temperature control system 714, such as a resistive heating element, within the container. Optionally, the strap-based configuration may be enclosed within a secondary containment bag, similar to those described in other pressure control system embodiments, for added environmental protection and redundancy.

d. Lattice-Based Pressure Control System

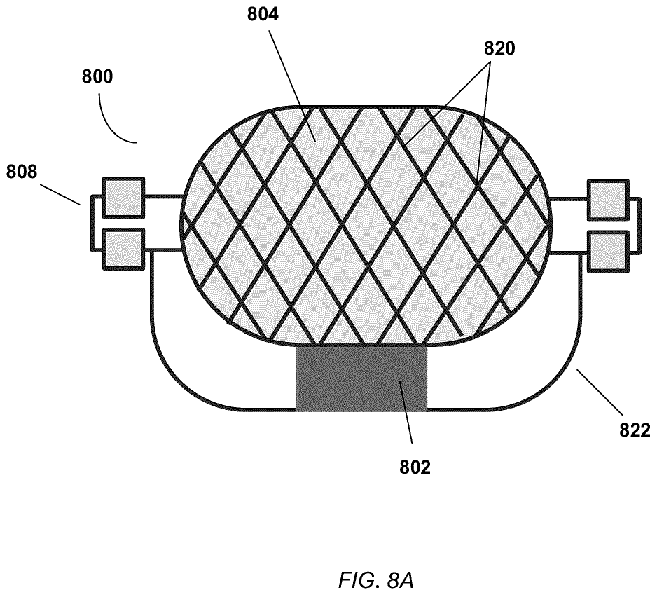

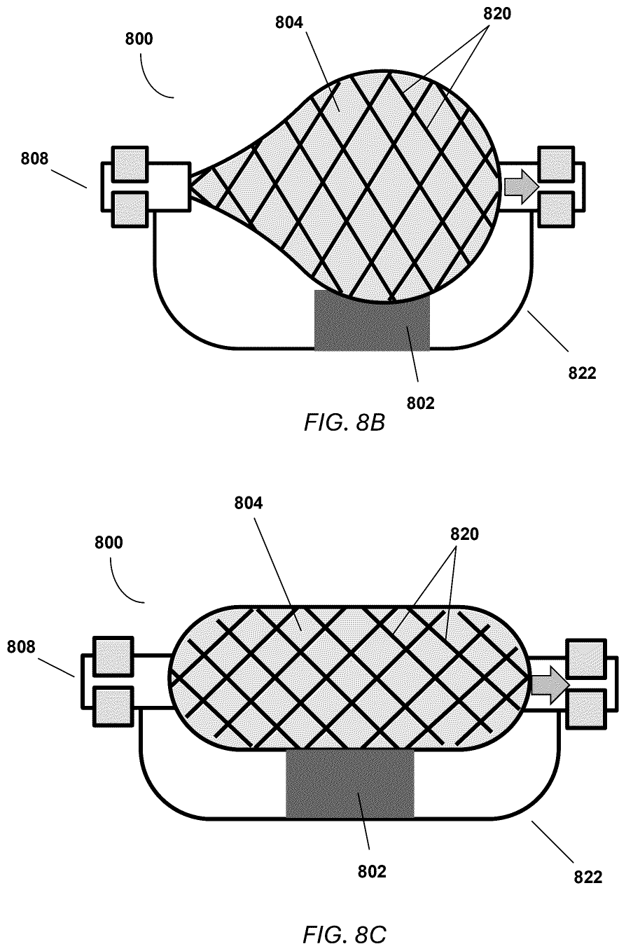

With reference to FIGS. 8A-C, another embodiment of a pressure control system 800 is shown, referred to herein as a lattice-based pressure control system. In this embodiment, the container 804 is enclosed by a surrounding lattice 820, which can comprise an array of lightweight, semi-rigid struts arranged in a repeating, flexible geometric pattern that wraps around the entire circumference of the container 804 from end to end. The lattice 820 is configured to apply pressure to the container 804 by dynamically altering its geometry and compressing inward when tension is applied. Each strut in the lattice 820 may be formed from a strong yet slightly flexible material, such as carbon-fiber composites, spring steel, Vectran-reinforced polymers, or other aerospace-grade materials. The lattice may follow a helical, mesh, or truss-like configuration and is designed to conform to the outer surface of the container 804 while maintaining overall mechanical strength and flexibility.

To generate pressure, the system 800 may include an expandable arm 822 or actuator affixed to one or both ends of the container 804. When actuated (as shown in FIGS. 8B-C), the expandable arm 822 pulls or tugs on the lattice, causing it to stretch longitudinally and simultaneously constrict radially, thus tightening the lattice around the container. This geometric transformation compresses the container 804, increasing internal pressure sufficient to keep any fluid in a liquid state in a vacuum environment. The generated pressure also directs the fluid toward the fluid transport assembly 808, allowing for controlled dispensing when a valve is open. In some embodiments, the lattice may be configured such that differential pressure can be applied to assist with fluid movement, e.g., as shown in FIG. 8B, thus moving fluid within the container to the fluid transport assembly. The expandable arm 822 or actuator may further be affixed to a frame 802, thereby anchoring the pressure control system 800 to the liquid transport system.

The container 804 in this embodiment may include the same three-layer structure described previously: a primary bladder layer, a structural support layer, and an outer gas-impermeable surface that interacts with the constricting lattice. The lattice-based system offers a mechanically robust and reusable alternative to inflatable or belt-based pressure systems and may be especially advantageous in applications requiring non-uniform pressure application without reliance on gas inflation or where deployable structures are desired.

e. Multi-Bag Configurations

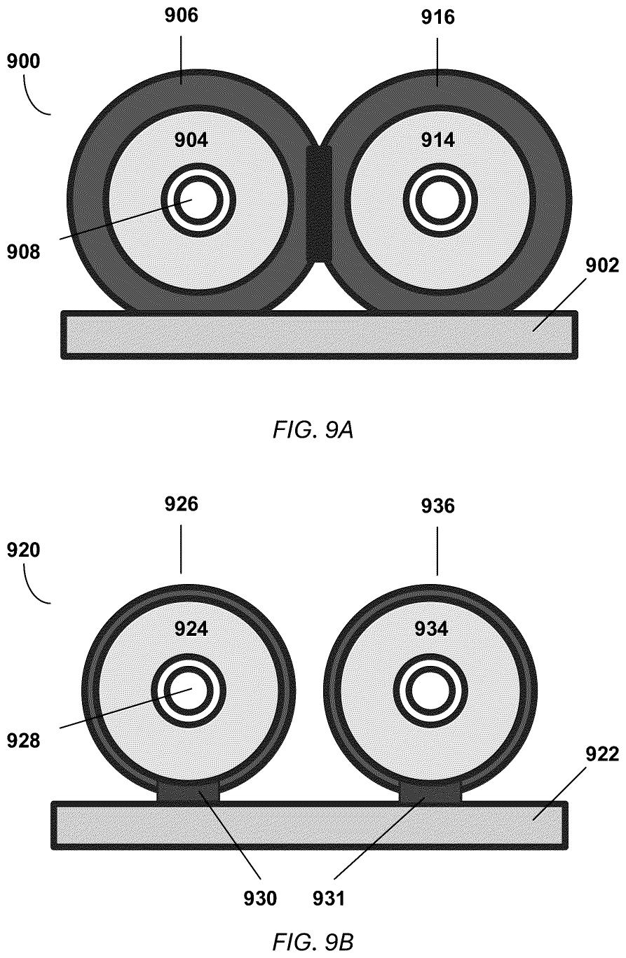

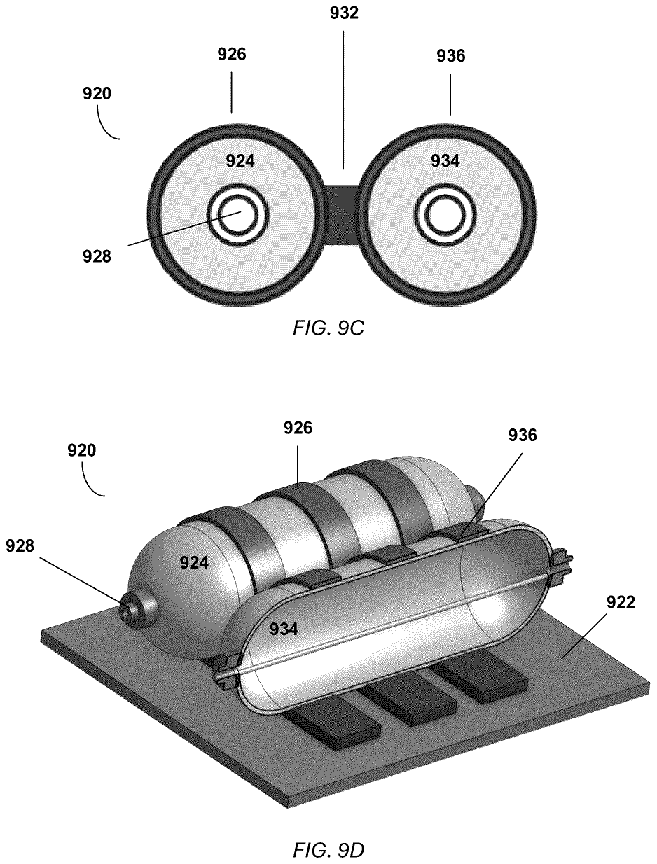

With reference to FIGS. 9A-9C, additional embodiments are shown illustrating pressure control systems configured for use with multiple adjacent containers. These multi-bag configurations provide modularity and scalability for larger fluid storage and transfer operations, while retaining the benefits of localized pressure control mechanisms. They also allow multiple pressure-controlled containers to operate in tandem, enabling scalable and flexible storage without requiring a single large monolithic tank. Different combinations of pressure control systems may also be used, e.g., combined donut-based and strap-based systems within a common modular framework, depending on mission-specific performance, control, or environmental needs.

As shown in FIG. 9A, a multi-bag donut system 900 according to one embodiment of the disclosure comprises two independent containers 904, 914 and pressure control systems 906, 916 positioned side-by-side. As previously described herein, each container 904, 914 can comprise a flexible, collapsible tank (e.g., the container 104 of FIG. 1) surrounded by a series of inflatable donuts arranged along the length of the container, forming a donut-based pressure control system as described herein. The donuts are configured to apply external pressure to maintain the fluid in a liquid state and to assist in transporting fluid toward, e.g., a fluid transport assembly 908. In some embodiments, the pressure control systems of each container are affixed to a common frame 902 or housed within a shared enclosure for structural support. Each system may be individually operable or connected jointly, for example by a shared fluid transport assembly or inter-module connector, allowing fluid to be selectively transferred between the two containers.

As shown in FIGS. 9B-D, a multi-bag belt system 940 according to one embodiment of the disclosure can comprise two or more containers (924, 034) each surrounded by a pressure control system 926, 936, which in this embodiment comprises a series of tensioned straps or belts configured to apply mechanical compression. The belts may be constructed from high-strength materials such as nylon, Kevlar, Vectran, or similar materials as described herein. The two pressure control systems may be independently tensioned using individual strap motors (FIG. 9B, strap motors 930, 931), or using a single strap motor (FIG. 9C, strap motor 932) or motorized pulley system as previously described herein. Similarly, the two units may share coordinated control, temperature, and sensor systems, or use separate systems for redundancy purposes. Like the donut-based system, the multi-bag belt configuration may allow for fluid sharing or transfer between adjacent containers via valves, connectors, or mating interfaces. This configuration provides fine-grained pressure control with mechanical redundancy and may be particularly well suited for modular deployments where adjustable structural integration and precision actuation are desired.

### C. Exemplary Method

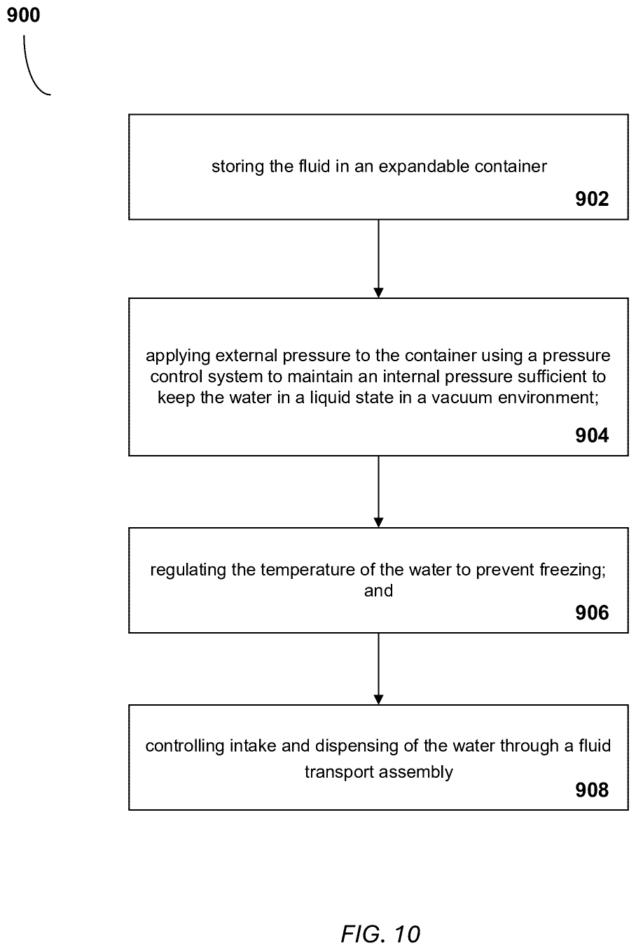

In some embodiments, the present disclosure provides a method 1000 of transporting a fluid, such as water, in space using a liquid transport system as described herein. As shown in FIG. 10, the method 1000 can comprise storing the fluid in an expandable container (e.g., the container 104) (step 1002). The container may comprise one or more flexible materials and may include the multi-layered construction described above, such as a primary bladder layer for fluid containment, a structural layer for pressure resistance, and an optional gas-impermeable outer layer. The expandable nature of the container allows it to compress and expand based on the volume of fluid inside, facilitating efficient storage and minimizing volume during launch or transport.

External pressure is applied to the container using a pressure control system (e.g., system 112) to maintain an internal pressure sufficient to keep the fluid in a liquid state in a vacuum environment (step 1004). In some embodiments, applying external pressure comprises inflating one or more bladders (e.g., donuts 502, 504, 506) surrounding the container, which when expanded, apply compressive force to the container. In other embodiments, external pressure may be applied by constricting one or more belts (e.g., straps 722, 724, 726), which tighten around the container via strap motors to generate internal pressure. In further embodiments, pressure may be applied using a dual-bag, lattice, or rigid outer shell design, as described in the pressure control system sections.

The temperature of the fluid may be regulated using a temperature control system (e.g., system 114) (step 1006). This may include active heating components such as resistive heaters or inductive elements positioned within or adjacent to the container, or passive heating components such as thermal domes or solar shields. Temperature regulation helps prevent freezing or boiling of the fluid, maintaining it in the liquid phase across a variety of thermal environments encountered in space.

The intake and dispensing of the fluid is controlled through a fluid transport assembly (e.g., assembly 108) (step 1008). The fluid transport assembly may include valves or connectors that allow for precise fluid handling between modules or with external systems. In some embodiments, controlled dispensing of the fluid through the fluid transport assembly generates thrust, such as in a propulsion system where liquid water is converted to plasma and expelled to reposition the module. Methods according to the disclosure can be adapted for various applications, including refueling spacecraft, supplying water to space stations, or storing cryogenic fluids, and supports modular, scalable fluid logistics across different orbital and planetary environments, as described herein.

### D. Example Use Cases

Liquid transport systems as described herein are highly modular, scalable, and adaptable to a wide variety of mission environments and technical requirements. These systems are particularly well-suited for deployment in space-based operations due to their ability to maintain fluid in a liquid state in vacuum conditions, provide modular interconnectivity, and enable controlled fluid intake and dispensing. The pressure control mechanisms described-including inflatable bladder systems, dual-bag configurations, lattice enclosures, and strap-based compression-allow for flexible deployment based on mission parameters such as destination, payload constraints, and operational duration.

In some scenarios, such as low Earth orbit (LEO), small and lightweight transport modules (e.g., 1500 liters) may be preferred due to their maneuverability, compatibility with rideshare deployment platforms, and frequent access to resupply or docking stations. These modules can be efficiently repositioned by autonomous logistics vehicles (ALVs) or similar space tugs, providing versatile support for near-Earth applications such as data center cooling, station resupply, satellite refueling, or space agriculture.

In other scenarios, such as deep-space exploration missions or long-duration deployments near outer planets or moons (e.g., Enceladus, Europa, or Titan), larger or interconnected systems may be preferred. These missions often require greater fluid storage capacity to support scientific research, life support systems, or multi-phase operations such as drilling, resource extraction, or atmospheric sampling. In such cases, multiple liquid transport units may be interconnected using the modular fluid transport assemblies described herein to form a fluid distribution network or expandable reservoir system.

The adaptability of the system to different fluids-including water, propellants, coolants, acids, bases, liquid metals, and biologically active fluids-further enhances its utility across a wide range of applications. These include, but are not limited to, propulsion, radiation shielding, thermal regulation, fuel storage, fluid dynamics research, chemical reactions, biological testing, and surface operations in low-gravity environments. The following sections outline specific use cases organized by orbital region, planetary target, or functional domain, demonstrating the wide-ranging applicability of the liquid transport systems disclosed herein.

i. Near-Earth Applications

In Low Earth Orbit (LEO), Geostationary Orbit (GEO), and cis-lunar space, the modular liquid transport systems described herein provide an economical and scalable platform for delivering and managing fluids across a variety of operational contexts. Their relatively small form factor, compatibility with standardized payload enclosures (e.g., Falcon fairing compartments, Starlink PEZ dispenser), and modularity make them especially well-suited to LEO operations, including orbital infrastructure, commercial satellite support, and emerging in-space manufacturing and tourism markets. The system's adaptability to standard interfaces and its modular scalability make it ideal for integration with existing spacecraft, servicing platforms, or autonomous logistics vehicles operating in LEO. Various uses in near-Earth space are outlined below.

| Use Case | Description |
|---|---|
| Orbital Cooling | The liquid transport system may carry coolant fluid (e.g., glycol-water |
| Systems | mixtures or dielectric fluids) to service or supply space-based data centers, |
| | which are being explored as a means of offloading computational workloads |
| | and leveraging thermal advantages in orbit. |
| ISS Resupply | The system may deliver potable water or experimental fluids to the |
| | International Space Station (ISS) or future orbital habitats. Water may be |
| | used for drinking, hygiene, research, hydroponics, or electrolysis-based fuel |
| | generation. |
| Satellite | In some embodiments, the system may store propellants such as hydrazine, |
| Refueling | liquid hydrogen, or green monopropellants, enabling on-orbit refueling of |
| Depots | aging satellites or servicing missions, especially as refueling infrastructure |
| | becomes commercially viable. |
| Radiation | Water or other hydrogen-rich fluids may be stored in modular tanks and |
| Shielding | positioned around crewed modules to shield astronauts from radiation in |
| | LEO or cis-lunar space. |
| Scientific | The container may be filled with experimental fluids such as mercury or |
| Research | nutrient-rich solutions to support fluid dynamics research, agricultural |
| | studies, or biological testing in microgravity. |
| Maintenance and | The system may dispense water or specialized fluids for cleaning satellite |
| Cleaning | surfaces, such as solar panels, or for releasing fluids to seal minor leaks in |
| | orbital structures using fast-hardening compounds. |
| Atmospheric and | In other embodiments, the system may be used to dispense fluid for upper- |
| Propulsion | atmosphere weather experiments or serve as a testbed for novel propulsion |
| Testing | systems that rely on water or other storable fluids. |

ii. Planetary Applications

Outside Earth orbit, liquid transport systems may be deployed in orbit around other planets or delivered to the surface of those planets or their moons. In these environments, larger tanks (e.g., 10,000 liters or more) may be preferred to reduce the frequency of supply missions and to maximize utility for extended operations. Because transport windows to planetary destinations such as Mars, Jupiter, or Saturn are infrequent and involve long-duration transits, a larger-volume fluid system may provide operational and logistical advantages over multiple smaller tanks.

The pressure control and thermal regulation systems described herein enable storage of fluids under vacuum and across a wide range of planetary surface and orbital conditions. Systems may be used alone or in modular chains, and may be repositioned by autonomous vehicles or integrated with in-situ infrastructure.

### Mars

| Use Case | Description |
|---|---|
| Terraforming | Deliver water to be released as vapor for controlled atmospheric |
| Research | modification experiments. |
| Rover Refueling | Supply liquid methane or oxygen to support long-range surface mobility |
| | platforms. |
| Habitat Cooling | Provide a coolant loop for orbital or surface bases during day-night |
| | cycles. |
| Atmospheric and | Dispense tracer fluids into the atmosphere to study wind currents during |
| Dust Monitoring | dust storms. |
| Mineral Processing | Store or circulate mercury or other fluids for in-orbit or surface-based |
| | ore processing tests. |

### Venus

| Use Case | Description |
|---|---|
| Atmospheric | Use corrosion-resistant fluids or sealed collection chambers to analyze |
| Sampling | acidic clouds in the upper atmosphere. |
| Floating Platform | Store and circulate coolants on high-altitude Venusian balloon platforms. |
| Cooling | |
| Thermal Protection | Dispense or circulate fluids as part of high-temperature materials testing |
| Testing | in Venus's intense thermal environment. |

### Jupiter and Saturn

| Use Case | Description |
|---|---|
| Radiation Shielding | Deploy water as a shield around sensitive electronics in orbit near high- |
| | radiation zones. |
| Long-Distance | Store hydrogen for deep-space transit legs toward outer moon targets |
| Fueling | like Europa or Titan. |
| Atmospheric | Release tracer fluids to study the dynamics of planetary atmospheres or |
| Science | magnetospheres. |
| Cryogenic | Maintain storable fuels in orbit for future missions to the Jovian or |
| Propellant Reserve | Saturnian systems. |

iii. Lunar and Moons-Based Operations

Modular liquid transport systems as described herein are well suited for applications in low-gravity environments such as Earth's Moon, Jupiter's Europa, Saturn's Titan and Enceladus, and Neptune's Triton. These bodies offer unique opportunities for exploration, science, resource extraction, and long-duration surface habitation. Each environment presents distinct challenges such as radiation exposure, thermal extremes, or terrain variability that may affect mission duration and fluid requirements. In certain cases, smaller 1500 L modules may be ideal for precise transport, whereas in others, such as extended missions or heavy-duty applications, multiple interconnected modules or larger-volume tanks (e.g., 10,000 L or more) may be preferred.

### Earth's Moon

| Use Case | Description |
|---|---|
| Lunar Base Water | Deliver water for drinking or oxygen production. |
| Supply | |
| Fuel for Hoppers | Store propellant for lunar surface transport vehicles. |
| Cooling Lunar Data | Use fluid to cool computing equipment in a lunar orbit station. |
| Center | |
| Regolith Processing | Contain mercury for experimental mineral extraction from lunar soil. |
| Hover Transport | Dispense fuel for a hovering vehicle above the ⅙th Earth gravity |
| | surface. |

### Europa (Jupiter)

| Use Case | Description |
|---|---|
| Ocean Drilling Fluid | Store water or coolant for probes penetrating Europa's ice. |
| Radiation Shielding | Use water to protect orbiters from Jupiter's radiation. |
| Fuel for Landers | Provide propellant for surface exploration vehicles. |
| Hover Operations | Supply fuel for a hovering craft above Europa's 13% Earth gravity |
| | surface. |
| Biological Research | Hold nutrient fluid for studying potential subsurface life. |

### Titan (Saturn)

| Use Case | Description |
|---|---|
| Lake Sampling | Store fluid to mix with and analyze Titan's methane lakes. |
| Fuel for Drones | Provide liquid methane for aerial drones in Titan's atmosphere. |
| Cooling Orbiters | Use coolant to manage temperatures in Titan's orbit. |
| Hover Transport | Dispense fuel for hovering vehicles over Titan's 14% Earth gravity |
| | surface. |
| Atmospheric Chemistry | Release tracer fluid to study Titan's thick atmosphere. |

### Enceladus (Saturn)

| Use Case | Description |
|---|---|
| Plume Analysis | Contain fluid to capture and study Enceladus's water vapor geysers. |
| Fuel for Probes | Store propellant for subsurface ocean explorers. |
| Cooling Systems | Supply coolant for orbiters near Enceladus's icy surface. |
| Hover Craft | Provide fuel for hovering above Enceladus's 1% Earth gravity |
| | surface. |
| Ice Melting | Use heated water to assist in surface penetration experiments. |

### Triton (Neptune)

| Use Case | Description |
|---|---|
| Cryovolcano Study | Release fluid to interact with Triton's nitrogen geysers. |
| Fuel Reserve | Store propellant for orbiters or landers exploring Triton. |
| Cooling Equipment | Use coolant for instruments enduring Neptune's cold. |
| Hover Transport | Supply fuel for hovering vehicles over Triton's 8% Earth gravity |
| | surface. |
| Surface Mapping | Dispense tracer fluid for high-resolution atmospheric studies. |

iv. Deep Space and Interstellar Missions

### Beyond the Solar System

| Use Case | Description |
|---|---|
| Interstellar Probe Fuel | Store liquid hydrogen for propulsion on a deep-space mission. |
| Cooling for AI Systems | Use coolant to maintain data centers on an interstellar craft. |
| Water for Crew | Provide drinking water for a generation ship's inhabitants. |
| Radiation Shielding | Use water to protect against cosmic rays in interstellar space. |
| Exoplanet Study | Release tracer fluid to analyze exoplanet atmospheres during |
| | flybys. |

### General Scientific and Industrial Uses

| Use Case | Description |
|---|---|
| Fluid Dynamics | Study mercury behavior in microgravity across various orbits. |
| Research | |
| Coolant Distribution | Supply fluid to a network of small satellites for thermal |
| | management. |
| Fuel Synthesis | Store water to split into hydrogen and oxygen for propulsion. |
| Chemical Reactions | Use fluid as a medium for in-space chemical experiments. |
| Biological Testing | Contain nutrient fluid for growing organisms in space. |

### V. Scientific and Industrial Applications

In addition to mission-specific roles, the liquid transport system can support a wide range of scientific experiments, industrial operations, and general utility functions across various orbital and planetary contexts. These applications benefit from the system's modularity, fluid control features, and ability to store diverse liquids, including specialty fluids like mercury or nutrient-rich media. Smaller 1500-liter units may be preferred for modular deployment on small satellites or orbital labs, while larger configurations could be used in space factories, permanent habitats, or research stations.

| Use Case | Description |
|---|---|
| Fluid Dynamics | Study mercury behavior in microgravity across various orbits. |
| Research | |
| Coolant Distribution | Supply fluid to a network of small satellites for thermal management. |
| Fuel Synthesis | Store water to split into hydrogen and oxygen for propulsion. |
| Chemical Reactions | Use fluid as a medium for in-space chemical experiments. |
| Biological Testing | Contain nutrient fluid for growing organisms in space. |

vi. Resource Storage and Delivery

| Use Case | Description |
|---|---|
| Asteroid Mining Support | Store water extracted from asteroids for processing. |
| Comet Harvesting | Hold fluid captured from comet tails for analysis. |
| Mercury Reserve | Store liquid mercury for industrial use in space manufacturing. |
| Oxygen Generation | Use water to produce breathable air via electrolysis. |
| Emergency Supply | Hold reserve fluid for unexpected spacecraft needs. |

vii. Specialized Applications

Modular liquid transport systems as described herein are adaptable to a wide range of specialized applications. These use cases highlight the system's versatility beyond conventional industrial and scientific needs, showcasing its value for creative, experimental, and advanced technical scenarios in space environments.

| Use Case | Description |
|---|---|
| Space Art | Release colored fluid for visual experiments in orbit. |
| Laser Cooling | Use fluid in a laser-based cooling system for quantum experiments. |
| Magnetic Levitation | Contain mercury for magnetic field studies in space. |
| Heat Transfer | Use fluid to test heat pipe systems in microgravity. |
| Sound Wave Testing | Study fluid vibrations in space for acoustic research. |

viii. Extreme Environments

| Use Case | Description |
|---|---|
| Solar Proximity | Store coolant to protect a satellite operating near the Sun from |
| | overheating due to intense solar radiation. |
| Kuiper Belt Mission | Hold fuel reserves for spacecraft on long-duration exploration |
| | missions through the Kuiper Belt region. |
| Oort Cloud Probe | Use water as a vital onboard resource to support distant robotic |
| | missions exploring the outer reaches of the solar system. |
| Black Hole Study | Release fluid to observe gravitational effects near high-mass stellar |
| | remnants, such as black holes, for scientific research. |
| Neutron Star | Contain mercury or other dense fluids to test extreme magnetic field |
| Observation | interactions in orbits near neutron stars. |

ix. Surface and Hovering Operations

| Use Case | Description |
|---|---|
| Space Art | Release colored fluid for visual experiments in orbit. |
| Laser Cooling | Use fluid in a laser-based cooling system for quantum experiments. |
| Magnetic Levitation | Contain mercury for magnetic field studies in space. |
| Heat Transfer | Use fluid to test heat pipe systems in microgravity. |
| Sound Wave Testing | Study fluid vibrations in space for acoustic research. |
| Solar Proximity | Store coolant to protect a satellite near the Sun. |
| Kuiper Belt Mission | Hold fuel for long-duration exploration in the outer solar system. |
| Oort Cloud Probe | Use water as a resource for a distant robotic mission. |
| Black Hole Study | Release fluid to observe gravitational effects near a stellar remnant. |
| Neutron Star | Use mercury to test extreme magnetic field interactions. |
| Observation | |

x. Niche and Specialized Applications

| Use Case | Description |
|---|---|
| Lunar Rover | Provide fuel for rovers in a 1% gravity environment. |
| Refueling | |
| Hovering Science Lab | Supply fluid for a mobile lab floating above a moonâ€ ™s surface. |
| Aerial Delivery | Drop water or fuel to surface teams from orbit. |
| Gravity Simulation | Use fluid weight to mimic higher gravity in experiments. |
| Surface Cleaning | Dispense fluid to clear debris from landing sites. |
| Space Tourism | Offer water for luxury orbital hotels. |
| Debris Capture | Use fluid to trap small orbital debris for cleanup. |
| Signal Enhancement | Release fluid to amplify radio signals in space. |
| Thermal Battery | Store fluid to retain and release heat for power. |
| Holography | Use fluid in microgravity to create 3D holographic displays. |
| Space Weather | Release fluid to study solar wind interactions. |
| Crystal Growth | Contain fluid for growing large crystals in orbit. |
| Medical Research | Store fluid for pharmaceutical experiments in space. |
| Education Outreach | Use fluid in live demos for students from orbit. |
| Backup System | Hold reserve fluid for any unforeseen mission needs. |

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the systems and methods described herein. It is intended that the following claims define the scope of the what is claimed and that methods and structures within the scope of these claims and their equivalents be covered thereby.

1. A system for transporting a liquid in space, the system comprising:
an expandable container configured to store a liquid, the container comprising a flexible, collapsible material;
a pressure control system in mechanical communication with the expandable container, the pressure control system comprising a plurality of circumferential belts surrounding the expandable container, each belt coupled to a corresponding strap motor configured to selectively tighten the belt around the expandable container to compress a volume of the expandable container and thereby maintain an internal pressure sufficient to keep the liquid in a liquid state in a vacuum environment;
a fluid transport assembly coupled to the expandable container, the fluid transport assembly comprising at least one nozzle configured for intake and dispensing of the liquid; and
a control system configured to regulate an operation of the pressure control system and the fluid transport assembly to enable controlled intake and dispensing of the liquid.

2. The system of claim 1, wherein the liquid is a non-volatile fluid selected from the group consisting of water and oil, or a volatile fluid selected from a group consisting of methane, butane, and natural gas.

3-6. (canceled)

7. The system of claim 1, further comprising a temperature control system in thermal communication with the container, the temperature control system configured to regulate a temperature of the liquid to prevent freezing or boiling.

8. The system of claim 7, wherein the liquid is water, and the temperature control system maintains the water at a minimum temperature of 10° C. and a maximum temperature of 95° C.

9. The system of claim 1, wherein the pressure control system is further configured to regulate a deposit and/or withdrawal of the liquid through the fluid transport assembly and maintain an internal pressure of at least 0.0425 bar within the container.

10-11. (canceled)

12. The system of claim 1, wherein the pressure control system comprises one or more inflatable bladders surrounding the container, each inflatable bladder configured to apply an external force to the container when inflated to maintain the internal pressure.

13. The system of claim 1, wherein the pressure control system comprises a liquid crystal polymer layer surrounding the container, wherein the liquid crystal polymer layer applies an external force to maintain the internal pressure.

14-16. (canceled)

17. The system of claim 1, wherein the pressure control system comprises a lattice surrounding the container, wherein constricting the lattice applies an external force to maintain the internal pressure, wherein the lattice is constricted by stretching the lattice laterally over the container.

18. (canceled)

19. The system of claim 1, further comprising a second expandable container, wherein the second expandable container is stacked adjacent to the expandable container.

20. The system of claim 1, wherein the expandable container comprises at least three layers:
an outer protective layer providing protection from radiation and micrometeoroids;
a structural layer providing tensile strength and pressure resistance; and
a primary bladder layer providing flexibility, water impermeability, and thermal protection.

21. (canceled)

22. The system of claim 1, wherein the fluid transport assembly further comprises a second nozzle, wherein the at least one nozzle is positioned on a proximal end of the container and the second nozzle is positioned on a distal end of the container.

23. The system of claim 1, wherein the fluid transport assembly is configured to provide thrust for the system by controlling dispensing of the liquid in space.

24. A modular frame comprising the system of claim 1, wherein the frame is configured to provide structural support and attachment points for the liquid transport system.

25. The modular frame of claim 24, wherein the fluid transport assembly of the system is in fluid communication with a fluid transport assembly of a second system, enabling the interconnected water transfer between multiple systems.

26. The modular frame of claim 25, wherein the modular frame is configured for attachment to a spacecraft.

27. A method of transporting a liquid in outer space, the method comprising:
storing the liquid in an expandable container;
applying external pressure to the container using a pressure control system to maintain an internal pressure sufficient to keep the liquid in a liquid state in a vacuum environment, wherein the pressure control system comprises a plurality of circumferential belts surrounding the expandable container, each belt being coupled to a corresponding strap motor, and wherein applying external pressure comprises selectively tightening one or more of the plurality of circumferential belts around the expandable container using one or more corresponding strap motors to compress a volume of the expandable container;
regulating the temperature of the liquid to prevent freezing; and
controlling intake and dispensing of the liquid through a fluid transport assembly.

28. The method of claim 27, wherein applying external pressure to the container comprises inflating one or more bladders surrounding the container to apply force to the container and maintain the internal pressure.

29-30. (canceled)

31. The method of claim 27, further comprising independently actuating the plurality of circumferential belts to apply different compressive forces along different regions of the expandable container

32. The system of claim 1, wherein the plurality of circumferential belts are independently actuatable to apply different compressive forces along different regions of the expandable container.

33. The system of claim 1, wherein selective tightening of one or more of the plurality of circumferential belts directs the liquid toward the fluid transport assembly.
